(19) United States
(12) Patent Application Publication
(10) Pub. No.: US 2026/0341090 A1
(43) Pub. Date: Oct. 29, 2026

(54) INFORMATION PROCESSING APPARATUS, INFORMATION PROCESSING METHOD, AND RECORDING MEDIUM

(71) Applicant: NEC Corporation, Minato-ku, Tokyo (JP)

(72) Inventor: Junichi KAMIMURA, Tokyo (JP)

(73) Assignee: NEC Corporation, Minato-ku, Tokyo (JP)

(21) Appl. No.: 19/121,471

(22) PCT Filed: Oct. 18, 2022
(86) PCT No.: PCT/JP2022/038818

§ 371 Date: Apr. 16, 2025

(51) Int. Cl. G07C 9/37; G06V 40/16; H04W 4/029

(52) U.S. Cl. CPC G07C 9/37; G06V 40/161; H04W 4/029

(57) ABSTRACT

An information processing apparatus includes: an image acquisition unit that acquires a first image including a predetermined area through which a plurality of authentication subjects pass; an information acquisition unit that acquires a position of a terminal apparatus carried by a user; and a determination unit that determines a priority degree of notification of a plurality of authentication results of face authentication performed by using the first image, based on the position of the terminal apparatus, and positions of the plurality of authentication subjects detected based on the first image.

### TECHNICAL FIELD

The present disclosure relates to technical fields of an information processing apparatus, an information processing method, and a recording medium.

### BACKGROUND ART

For example, there is proposed an apparatus that guides a user to a face authentication lane where identity verification is performed by face authentication, or to a face-to-face lane where identity verification is performed face-to-face, based on a result of matching/collating a face image acquired from the user with a plurality of registered face images in a database (see Patent Literature 1). Other prior art documents related to this disclosure include Patent Literatures 2 to 4.

### CITATION LIST

### Patent Literature

Patent Literature 1: JP2021-163457A

Patent Literature 2: JP2021-056869A

Patent Literature 3: JP2016-053896A

Patent Literature 4: WO2022/044086A1

### SUMMARY

### Technical Problem

It is an example object of the present disclosure to provide an information processing apparatus, an information processing method, and a recording medium that aim to improve the techniques/technologies disclosed in Citation List.

### Solution to Problem

An information processing apparatus according to an example aspect of the present disclosure includes: an image acquisition unit that acquires a first image including a predetermined area through which a plurality of authentication subjects pass; an information acquisition unit that acquires a position of a terminal apparatus carried by a user; and a determination unit that determines a priority degree of notification of a plurality of authentication results of face authentication performed by using the first image, based on the position of the terminal apparatus, and positions of the plurality of authentication subjects detected based on the first image.

An information processing method according to an example aspect of the present disclosure includes: acquiring a first image including a predetermined area through which a plurality of authentication subjects pass; acquiring a position of a terminal apparatus carried by a user; and determining a priority degree of notification of a plurality of authentication results of face authentication performed by using the first image, based on the position of the terminal apparatus, and positions of the plurality of authentication subjects detected based on the first image.

A recording medium according to an example aspect of the present disclosure is a recording medium on which a computer program that allows a computer to execute an information processing method is recorded, the information processing method including: acquiring a first image including a predetermined area through which a plurality of authentication subjects pass; acquiring a position of a terminal apparatus carried by a user; and determining a priority degree of notification of a plurality of authentication results of face authentication performed by using the first image, based on the position of the terminal apparatus, and positions of the plurality of authentication subjects detected based on the first image.

### BRIEF DESCRIPTION OF DRAWINGS

FIG. 1 is a block diagram illustrating an example of a configuration of an information processing apparatus.

FIG. 2 is a block diagram illustrating an example of a configuration of an airport system.

FIG. 3 is a plan view illustrating an example of a floor on which a boarding gate is provided at an airport.

FIG. 4 is a plan view illustrating an example of a virtual authentication area.

FIG. 5 is a block diagram illustrating another example of the configuration of the information processing apparatus.

FIG. 6 is a diagram illustrating an example of a face database provided in the information processing apparatus.

FIG. 7 is a diagram for describing passenger tracking processing.

FIG. 8 is a diagram illustrating an example of an ID correspondence table.

FIG. 9 is a diagram illustrating an example of an image.

FIG. 10 is a flowchart illustrating a tracking and authentication operation according to a second example embodiment.

FIG. 11 is a flowchart illustrating a determination operation according to the second example embodiment.

FIG. 12 is a diagram illustrating an example of a screen displayed on a terminal apparatus.

FIG. 13 is a block diagram illustrating an example of a configuration of an authentication apparatus.

FIG. 14 is a diagram illustrating another example of the screen displayed on the terminal apparatus.

FIG. 15 is a diagram illustrating another example of the screen displayed on the terminal apparatus.

FIG. 16 is a diagram illustrating another example of the screen displayed on the terminal apparatus.

FIG. 17 is a diagram illustrating another example of the screen displayed on the terminal apparatus.

FIG. 18 is a diagram illustrating another example of the screen displayed on the terminal apparatus.

FIG. 19 is a block diagram illustrating an example of a configuration of the terminal apparatus.

### DESCRIPTION OF EXAMPLE EMBODIMENTS

An information processing apparatus, an information processing method, and a recording medium according to example embodiments will be described.

### First Example Embodiment

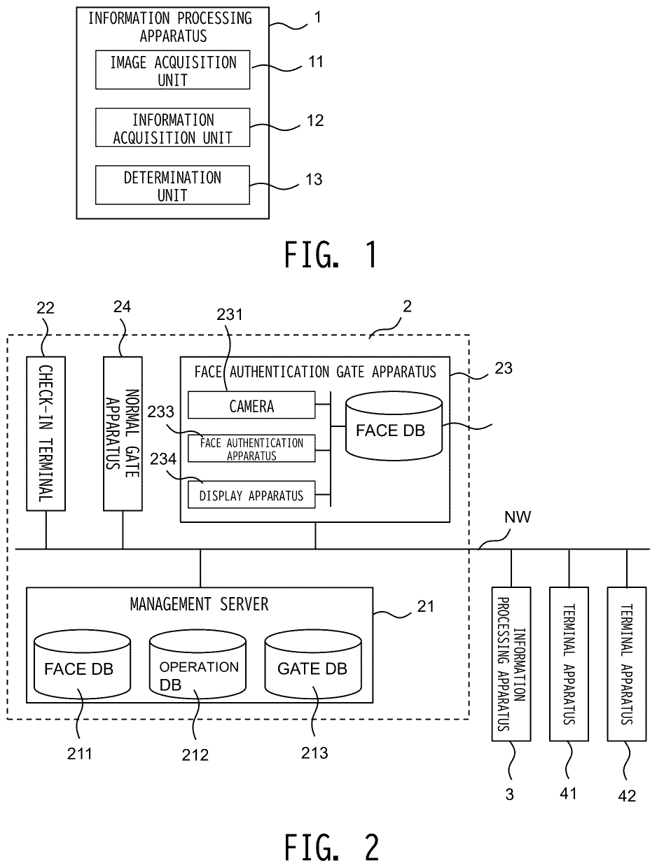

An information processing apparatus, an information processing method, and a recording medium according to a first example embodiment will be described with reference to FIG. 1. The following describes the information processing apparatus, the information processing method, and the recording medium according to the first example embodiment, by using an information processing apparatus 1. In FIG. 1, the information processing apparatus 1 includes an image acquisition unit 11, an information acquisition unit 12, and a determination unit 13.

The image acquisition unit 11 acquires an image including a predetermined area. Here, the predetermined area is an area through which a plurality of authentication subjects pass. Therefore, the image acquired by the image acquisition unit 11 may include one or more authentication subjects passing through the predetermined area.

The information acquisition unit 12 acquires a position of a terminal apparatus carried by a user. The terminal apparatus is configured to notify the user of at least a part of authentication results of face authentication performed by using the image acquired by the image acquisition unit 11. The user may be a different person from the plurality of authentication subjects. The user may be at least one of a guide and a security guard. The plurality of authentication results may correspond to the plurality of persons (i.e., the plurality of persons heading toward any one of the plurality of gate apparatuses), respectively.

The determination unit 13 determines a priority degree of notification of a plurality of authentication results respectively corresponding to the plurality of authentication subjects, based on a position of the terminal apparatus and positions of the plurality of authentication subjects. Here, the plurality of authentication results are the authentication results of the face authentication performed by using the images acquired by the image acquisition unit 11. For example, in a case where a distance between one authentication subject and the terminal apparatus is shorter than a distance between another authentication subject and the terminal apparatus, the determination unit 13 may set the priority degree of the authentication result of the one authentication subject, to be higher than the priority degree of the authentication result of the other authentication subject.

The terminal apparatus is configured to notify the user (e.g., at least one of a guide and a security guard) of at least a part of the authentication results of the face authentication. The terminal apparatus may display at least a part of the authentication results of the face authentication, based on the priority degree. For example, the terminal apparatus may display the authentication result with a high priority degree at the top of a screen/window, rather than the authentication result with a low priority degree. That is, the terminal apparatus may determine (or change) a display order of the authentication results, based on the priority degree. In other words, the terminal apparatus may change display content, based on the priority degree.

In many cases, the user is near the terminal apparatus. Therefore, the position of the terminal apparatus can be interpreted as a position of the user. By the way, the user hardly supports all the plurality of authentication subjects. By determining the priority degree of the authentication results based on the position of the terminal apparatus and the positions of the authentication subjects, and by changing the display content of the terminal apparatus based on the priority degree, it is possible to reduce the number of the authentication subjects to be supported by the user.

When the user supports the authentication subject, a time required to support the authentication subject located far from the user is considered to be longer than a time required to support the authentication subject located near the user. According to the information processing apparatus 1, the priority degree of the authentication results is determined based on the position of the terminal apparatus and the positions of the plurality of authentication subjects (e.g., the priority degree of the authentication subject close to the terminal apparatus is higher than that of the authentication subject far from the terminal apparatus), and the user is therefore expected to be able to efficiently support the authentication subject.

For example, the face authentication gate apparatus permits a person having succeeded in the face authentication to pass through, but does not permit a person having failed in the face authentication to pass through. The face authentication gate apparatus may determine that the face authentication is successful, when a face of a person attempting to pass through the face authentication gate apparatus corresponds to a face indicated by the face image registered in advance. In other words, the face authentication gate apparatus may determine that the face authentication is successful, when there is a person corresponding to the person attempting to pass through the face authentication gate apparatus, among those having pre-registered face images.

Therefore, in a case where the face image of the person attempting to pass through the face authentication gate apparatus is not registered, the face authentication gate apparatus does not permit the person to pass through (e.g., in a case where the face authentication gate apparatus is a flap-type gate apparatus, a flap is in a closed state). Therefore, when a person having no registered face image attempts to enter the face authentication gate apparatus, a flow of people passing through the face authentication gate apparatus is blocked due to the person not being permitted to pass through. That is, a throughput of the face authentication gate apparatus is reduced.

For example, the authentication result of the face authentication performed by using the image acquired by the image acquisition unit 11, may indicate whether or not the authentication subject is permitted to pass through the face authentication gate apparatus. In this case, the determination unit 13 may determine the priority degree of the authentication results such that the user is preferentially notified of the authentication result indicating that the authentication subject is not permitted to pass through the face authentication gate apparatus, based on the position of the terminal apparatus and the positions of the plurality of authentication subjects.

In this configuration, the user (e.g., at least one of a guide and a security guard) can preferentially support the person not being permitted to pass through the face authentication gate apparatus. As a result, it is possible to prevent/control the authentication subject not being permitted to pass through the face authentication gate apparatus from entering the face authentication gate apparatus. Therefore, according to the information processing apparatus 1, it is possible to prevent/control the reduction in a throughput of the face authentication gate apparatus.

In the information processing apparatus 1, the image acquisition unit 11 may acquire the image including the predetermined area through which a plurality of authentication subjects pass. The information acquisition unit 12 may acquire the position of the terminal apparatus carried by the user. The determination unit 13 may determine the priority degree of the plurality of authentication results of the face authentication performed by using the image, based on: the position of the terminal apparatus; and the positions of the plurality of authentication results detected based on the image.

Such an information processing apparatus 1 may be realized, for example, by a computer reading a computer program recorded on a recording medium. In this case, it can be said that on a recording medium, a computer program that allows a computer to execute an information processing method is recorded, the information processing method including: acquiring a first image including a predetermined area through which a plurality of authentication subjects pass; acquiring a position of a terminal apparatus carried by a user; and determining a priority degree of notification of a plurality of authentication results of face authentication performed by using the first image, based on the position of the terminal apparatus, and positions of the plurality of authentication subjects detected based on the first image.

### Second Example Embodiment

A information processing apparatus, a information processing method, and a recording medium according to a second example embodiment will be described with reference to FIG. 2 to FIG. 12. The following describes the information processing apparatus, the information processing method, and the recording medium according to the second example embodiment, by using an information processing apparatus 3 used at an airport.

First, the airport system 2 at the airport will be described with reference to FIG. 2. In FIG. 2, the airport system 2 includes a management server 21, a check-in terminal 22, and a plurality of gate apparatuses disposed at a boarding gate. The management server 21, the check-in terminal 22, and the plurality of gate apparatuses are connected to each other via a network NW.

The airport system 2 may include another check-in terminal, in addition to the check-in terminal 22. That is, the airport system 2 may include a plurality of check-in terminals. The network NW may be a wide area network (WAN) such as the Internet, or may be a local area network (LAN).

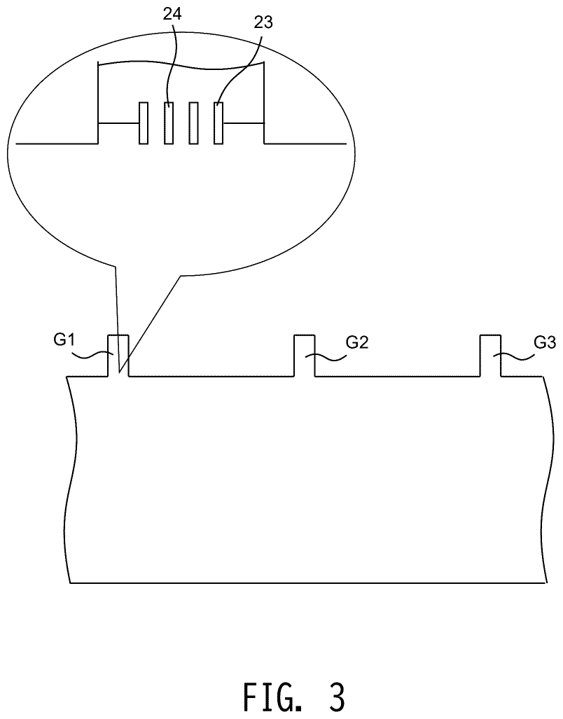

The plurality of gate apparatuses include a face authentication gate apparatus 23 that has a face authentication function of performing face authentication processing and that determines whether or not to permit a passenger to pass through depending on a result of the face authentication processing, and a gate apparatus 24 that determines whether or not to permit a passenger to pass through based on an airline ticket/boarding pass carried by the passenger. The gate apparatus 24 will be hereinafter referred to as a “normal gate apparatus 24” as appropriate. As illustrated in FIG. 3, let us assume that there are boarding gates G1, G2 and G3 at the airport. The face authentication gate apparatus 23 and the normal gate apparatus 24 are assumed to be disposed at the boarding gate G1.

The “airline ticket” may mean at least one of a paper airline ticket and an electronic airline ticket. The “airline ticket” may conceptually include, in addition to or in place of at least one of the paper airline ticket and the electronic airline ticket, those indicating personal information associated with the electronic airline ticket (e.g., a passport, a credit card used to purchase the airline ticket, etc.).

The management server 21 includes a face database 211 (hereinafter referred to as a “face DB 211”), an operation database 212 (hereinafter referred to as an “operation DB 212”), and a gate database 213 (hereinafter referred to as a “gate DB 213”).

In the face DB 211, a face image used for the face authentication processing is registered. In addition to or in place of the face image, a feature quantity relating to the face image may be registered in the face DB 211. In the operation DB 212, operation information (so-called flight information) about aircrafts is registered. The operation information may include a flight number of an aircraft, gate identification information for identifying the boarding gate (e.g., a boarding gate number), and a boarding start time. The flight number of the aircraft, the identification information, and the boarding start time may be associated with one another.

In the gate DB 213, a plurality of pieces of boarding gate information respectively corresponding to a plurality of boarding gates are registered. It should be noted that a party performing at least one of management and operation of the airport system 2 may be different from an airport company(s) performing the management and operation of the airport and from an airline company(s) performing the operation of aircrafts. In this case, the plurality of pieces of boarding gate information registered in the gate DB 213 may be acquired from a system(s) associated with at least one of the airport company(s) and the airline company(s). The gate DB 213 may be shared by the airport system 2 and by the system(s) associated with at least one of the airport company(s) and the airline company(s).

The boarding gate information may include gate identification information for identifying the boarding gate (e.g., a boarding gate number), and apparatus information about the disposed gate apparatuses. The apparatus information may be information indicating at least one of the number of the gate apparatuses, and a type, an operating status, and a disposed position of each gate apparatus. Here, the type of the gate apparatus may include a first type in which the face authentication is possible, and a second type in which the face authentication is not possible. The gate apparatus of the second type may include a gate apparatus configured to read those (e.g., a two-dimensional bar code, etc.) indicating information for identifying a passenger (e.g., an ID). The operating status of the gate apparatus may include an active state in which the gate apparatus is in operation and an inactive state in which the gate apparatus is paused/inactive (i.e., not in operation). The disposed position of the gate apparatus may be expressed as a relative positional relation of two or more gate apparatuses in a case where the two or more gate apparatuses are disposed at one boarding gate, for example. Alternatively, the disposed position of the gate apparatus may be expressed as coordinates of each gate apparatuses in a coordinate system of a floor on which the boarding gate is provided at the airport (a so-called departure floor), for example. In a case where only one gate apparatus is disposed at one boarding gate, the apparatus information may not include the disposed position of the gate apparatus. The inactive state may include a state in which no electric power is supplied to the gate apparatus (e.g., a power OFF state), and a state in which the gate apparatus is not allowed to perform its function even though electric power is supplied to a part of the gate apparatus (a so-called standby state). The plurality of pieces of boarding gate information registered in the gate DB 213 may be determined in advance depending on at least one of flights of aircrafts and airline companies. The plurality of pieces of boarding gate information registered in the gate DB 213 may be automatically updated in response to departure times of aircrafts or the like.

The check-in terminal 22 is a terminal used for a boarding procedure (i.e., check-in). The check-in terminal 22 may be operated by an airport staff or by a passenger (i.e., the check-in terminal 22 may be a so-called self-service check-in machine). The “airport staff” is not limited to those belonging to the airport company(s) that manages and operates the airport, but conceptually includes those working at the airport, such as those belonging to the airline company(s) that operates aircrafts.

The check-in terminal 22 performs the boarding procedure of a passenger, based on the airline ticket carried by the passenger. The check-in terminal 22 may acquire the face image of the passenger during the boarding procedure. The check-in terminal 22 may acquire the face image of the passenger by capturing an image of the passenger with a camera, or may acquire the face image of the passenger by reading a photograph of the face printed in a passport carried by the passenger. The check-in terminal 22 may not acquire the face images of all the passengers.

The check-in terminal 22 transmits, to the management server 21, passenger information about a passenger performing the boarding procedure (e.g., the passenger's name and the flight number of the aircraft) and the face image of the passenger. The check-in terminal 22 may acquire the passenger information from information described in the airline ticket (in other words, information associated with the airline ticket).

The management server 21 associates the passenger information and the face image transmitted from the check-in terminal 22, with each other, and registers them in the face DB 211. At this time, the management server 21 may add passenger identification information for identifying the passenger, to the passenger information and the face image. As described later, the face image is used for the face authentication processing. Therefore, the passenger identification information added to the passenger information and the face image will be hereafter referred to as an “authentication ID” as appropriate. The face image of the passenger may be acquired by an application (e.g., an application provided by an airline company) installed in a terminal apparatus (e.g., a smartphone) carried by the passenger, or may be acquired by a gate apparatus disposed in an immigration area of the airport, in addition to or in place of the check-in-terminal 22.

The management server 21 may identify the flight number of the aircraft, a first predetermined time (e.g., several minutes to tens of minutes) before the boarding start time, from the operation information registered in the operation DB 212, based on a current time. The management server 21 may extract the boarding gate information corresponding to the gate identification information, from the plurality of pieces of boarding gate information registered in the gate DB 213, based on the gate identification information associated with the identified flight number. The management server 21 may determine whether or not the face authentication gate apparatus (e.g., the face authentication gate apparatus 23) is disposed at the boarding gate corresponding to the extracted boarding gate information, based on the extracted boarding gate information.

When it is determined that the face authentication gate apparatus (e.g., the face authentication gate apparatus 23) is disposed, the management server 21 may extract, from the face DB 211, the face image of the passenger associated with the passenger information including the identified flight number (in other words, scheduled to board the aircraft with the identified flight number). The management server 21 may transmit the extracted face image to the face authentication gate apparatus (e.g., the face authentication gate apparatus 23) identified by the extracted boarding gate information. When it is determined that the face authentication gate apparatus is not disposed, the management server 21 may not perform the processing. When it is determined that the face authentication gate apparatus is disposed, the management server 21 may determine whether or not the disposed face authentication gate apparatus is in operation, based on the extracted boarding gate information. In a case where the feature quantity relating to the face image is registered in the face DB 211, the management server 21 may transmit the feature quantity relating to the face image to the face authentication gate apparatus, in addition to or in place of the face image.

The face authentication gate apparatus 23 includes a camera 231, a face database 232 (hereinafter referred to as a “face DB 232”), and a face authentication apparatus 233. The face image transmitted from the management server 21 is registered in the face DB 232. The face authentication gate apparatus 23 may include a display apparatus 234. The display apparatus 234 may display thereon at least one of an image captured by the camera 231 and information indicating a result of the face authentication processing.

The face authentication apparatus 233 performs the face authentication processing, by using the image captured by the camera 231 (e.g., the image in which a face of the passenger is captured) and the face image registered in the face DB 232. In a case where the face authentication is successful, the face authentication gate apparatus 23 permits the passenger to pass through. On the other hand, in a case where the face authentication is failed, the face authentication gate apparatus 23 does not permit the passenger to pass through. Various existing aspects (e.g., at least one of a two-dimensional (2D) authentication method and a three-dimensional (3D) authentication method) are applicable to the face authentication processing.

A specific example of the face authentication processing in the face authentication gate apparatus 23 will be described. The face authentication gate apparatus 23 may be a flap-type gate apparatus. The face authentication apparatus 233 may extract the feature quantity of the image captured by the camera 231. The face authentication apparatus 233 may collate/verify the extracted feature quantity with the feature quantity relating to the face image registered in the face DB 232. At this time, the face authentication apparatus 233 may calculate a matching score (or a similar score), based on the extracted feature quantity and the feature quantity relating to the face image registered in the face DB 232. When the matching score is greater than or equal to a threshold (i.e., when the face authentication is successful), the face authentication apparatus 233 may permit the passenger to pass through. At this time, the face authentication apparatus 233 may identify the authentication ID relating to the passenger. In this case, the face authentication gate apparatus 23 may open a flap. When the matching score is less than the threshold (i.e., when the face authentication is failed), the face authentication apparatus 233 may not permit the passenger to pass through. In this case, the face authentication gate apparatus 23 may close the flap. In addition to or in place of the face image, the feature quantity relating to the face image may be registered in the face DB 232.

Another apparatus (e.g., the management server 21) that differs from the face authentication gate apparatus 23 may perform a part of the face authentication processing. In this case, the face authentication apparatus 233 of the face authentication gate apparatus 23 may extract the feature quantity of the image captured by the camera 231. The face authentication apparatus 233 may transmit the extracted feature quantity to the other apparatus. The other apparatus may collate/verify the feature quantity transmitted from the face authentication apparatus 233 with the feature quantity relating to the face image registered in a face database (e.g., the face DB 211). The other apparatus may transmit information indicating a verification result (e.g., information indicating whether or not the matching score is greater than or equal to the threshold) to the face authentication gate apparatus 23. When the matching score is greater than or equal to the threshold, the other apparatus may include the authentication ID relating to the passenger, in the information indicating the verification result. In a case where the information indicating the verification result indicates that matching score is greater than or equal to the threshold, the face authentication apparatus 233 may permit the passenger to pass through. In a case where the information indicating the verification result indicates that matching score is less than the threshold, the face authentication apparatus 233 may not permit the passenger to pass through.

In the face authentication gate apparatus 23, a passing speed of the passenger is expectedly higher than that in the normal gate apparatus 24. In other words, the number of passengers passing through the face authentication gate apparatus 23 in a predetermined time period is expectedly greater than the number of passengers passing through the normal gate apparatus 24. That is, the face authentication gate apparatus 23 is capable of improving the throughput at the boarding gate.

As described above, however, a passenger being permitted to pass through the face authentication gate apparatus 23 is only a passenger having succeeded in the face authentication. In order for a passenger to succeed in the face authentication in the face authentication gate apparatus 23, the face image of the passenger needs to be registered in the face DB 232 of the face authentication gate apparatus 23. If a passenger having no face image registered in the face DB 232 enters the face authentication gate apparatus 23, the throughput at the boarding gate is reduced due to the passenger not being permitted to pass through.

To address this problem, for example, it is conceivable to extract (so-called screening) the passenger not being permitted to pass through the face authentication gate apparatus 23 before the passenger enters the face authentication gate apparatus 23.

In view of the above problem, the information processing apparatus 3 determines whether or not a passenger is permitted to pass through the face authentication gate apparatus 23 before the passenger enters the face authentication gate apparatus 23. That is, the information processing apparatus 3 determines whether or not a passenger is permitted to pass through the face authentication gate apparatus 23, separately from the face authentication gate apparatus 23.

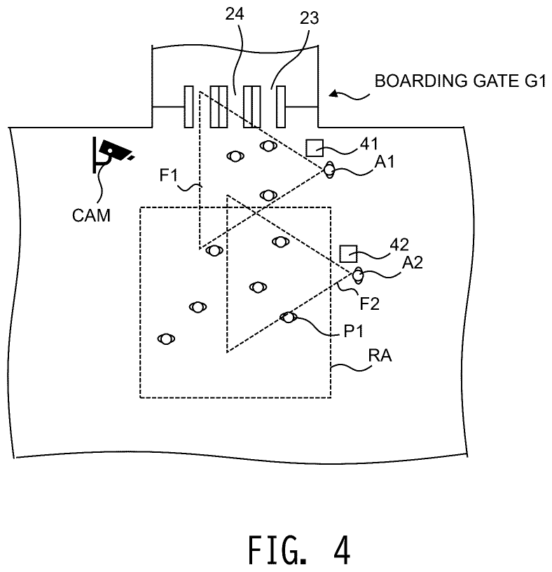

As illustrated in FIG. 4, a virtual authentication area RA is provided around the boarding gate G1 in which the face authentication gate apparatus 23 and the normal gate apparatus 24 are disposed. The authentication area RA is an area through which a plurality of passengers pass toward one of the face authentication gate apparatus 23 and the normal gate apparatus 24. The authentication area RA corresponds to an example of the “predetermined area” in the first example embodiment described above.

Furthermore, airport staff members (e.g., at least one of a guide and a security guard) A1 and A2 are located near the boarding gate G1. The staff member A1 carries a terminal apparatus 41. The staff member A2 carries a terminal apparatus 42. As illustrated in FIG. 2, the terminal apparatuses 41 and 42 are connected to the information processing apparatus 3 via the network NW. Note that “carry” is not limited to a meaning of “wearing”. For example, even when the terminal apparatus 41 aways/separates from the staff member A1, if he/she effectively controls the terminal apparatus 41, it may be interpreted that he/she carries the terminal apparatus 41. The terminal apparatuses 41 and 42 may include any one of a tablet terminal, a smartphone, and Augmented Reality (AR) glasses. The staff members A1 and A2 correspond to the “user” in the first example embodiment described above. At least one of the terminal apparatuses 41 and 42 may constitute a part of the airport system 2. In other words, the airport system 2 may include at least one of the terminal apparatuses 41 and 42. In addition to the terminal apparatuses 41 and 42, there may be another terminal apparatus. That is, there may be three or more terminal apparatuses.

A camera CAM is disposed so as to image/capture the authentication area RA. The camera CAM may be connected to the information processing apparatus 3 via the network NW. The camera CAM may not be disposed to include all of the authentication area RA in its angle of view. In other words, the camera CAM may be disposed to image/capture at least a part of the authentication area RA. The camera CAM may be disposed at a position that does not interfere with the passage of passengers (e.g., at a position that is higher than the passengers' heads). As described later, an image captured by the camera CAM may be used for the face authentication processing. Therefore, the camera CAM may be a high-resolution camera, such as a 4K resolution camera. The camera CAM may not be connected to the information processing apparatus 3 via the network NW. In this instance, the camera CAM may be connected to the information processing apparatus 3 via a cable (e.g., a USB (Universal Serial Bus) cable).

The camera CAM may generate a first image that is an image including the authentication area RA, by imaging the authentication area RA. The first image may be an image corresponding to one frame of a video.

The information processing apparatus 3 performs the face authentication processing by using the first image generated by the camera CAM imaging the authentication area RA, and determines, before a passenger included in the first image enters the face authentication gate apparatus 23, whether or not the passenger is permitted to pass through the face authentication gate apparatus 23. Hereinafter, the information processing apparatus 3 will be specifically described.

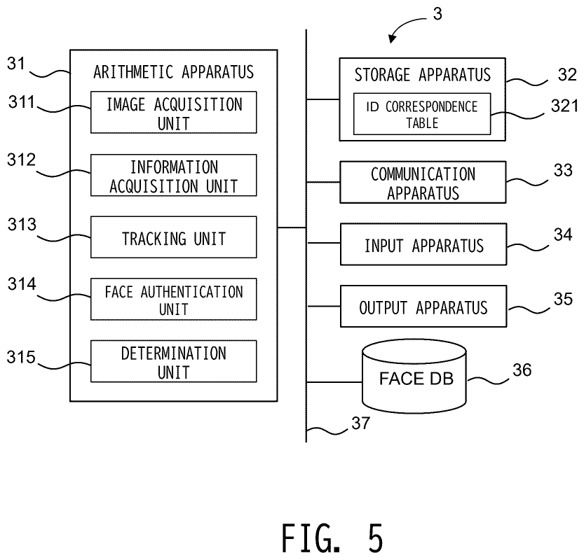

As illustrated in FIG. 5, the information processing apparatus 3 includes an arithmetic apparatus 31, a storage apparatus 32, and a communication apparatus 33. The information processing apparatus 3 may include an input apparatus 34 and an output apparatus 35. The information processing apparatus 3 may include a face database 36 (hereinafter referred to as a “face DB36”). The information processing apparatus 3 may not include at least one of the input apparatus 34 and the output apparatus 35. In the information processing apparatus 3, the arithmetic apparatus 31, the storage apparatus 32, the communication apparatus 33, the input apparatus 34, the output apparatus 35, and the face DB36 may be connected via a data bus 37. The information processing apparatus 3 is connected to the management server 21 via the communication apparatus 33 and the network NW. The information processing apparatus 3 may constitute a part of the airport system 2. In other words, the airport system 2 may include the information processing apparatus 3.

The arithmetic apparatus 31 may include, for example, at least one of a CPU (Central Processing Unit), a GPU (Graphics Processing Unit), a FPGA (Field Programmable Gate Array), a TPU (Tensor Processing Unit), and a quantum processor.

The storage apparatus 32 may include, for example, at least one of a RAM (Random Access Memory), a ROM (Read Only Memory, a hard disk apparatus, a magneto-optical disk apparatus, and a SSD (Solid State Drive), and an optical disk array. That is, the storage apparatus 32 may include a non-transitory recording medium. The storage apparatus 32 is configured to store desired data. For example, the storage apparatus 32 may temporarily store a computer program to be executed by the arithmetic apparatus 31. The storage apparatus 32 may temporarily store data that are temporarily used by the arithmetic apparatus 31 when the arithmetic apparatus 31 executes the computer program.

The communication apparatus 33 is configured to communicate with the management server 21 via the network NW. The communication apparatus 33 may be configured to communicate with an apparatus external to the information processing apparatus 3, other than the management server 21, via the network NW. The communication apparatus 33 may perform wired communication or may perform wireless communication.

The input apparatus 34 is an apparatus that is configured to receive an input of information to the information processing apparatus 3 from the outside. It may include an operating apparatus (e.g., a keyboard, a mouse, a touch panel, etc.) that is operable by an operator of the information processing apparatus 3. The input apparatus 34 may include a recording medium reading apparatus that is configured to read information recorded on a recording medium that is detachable from the information processing apparatus 3, such as, for example, a USB memory. When information is inputted to the information processing apparatus 3 via the communication apparatus 33 (in other words, when the information processing apparatus 3 acquires information via the communication apparatus 33), the communication apparatus 33 may function as an input apparatus.

The output apparatus 35 is an apparatus that is configured to output information to the outside of the information processing apparatus 3. The output apparatus 35 may output, as the above information, visual information such as characters and images, may output auditory information such as sound/audio, or may output tactile information such as vibrations. The output apparatus 35 may include, for example, at least one of a display, a speaker, a printer, and a vibrating motor. The output apparatus 35 may be configured to output information to a recording medium that is detachable from the information processing apparatus 3, such as, for example, a USB memory. When the information processing apparatus 3 outputs the information via the communication apparatus 33, the communication apparatus 33 may function as an output apparatus.

The arithmetic apparatus 31 may include an image acquisition unit 311, an information acquisition unit 312, a tracking unit 313, a face authentication unit 314, and a determination unit 315, as logically realized functional blocks, or physically realize processing circuits. At least one of the image acquisition unit 311, the information acquisition unit 312, the tracking unit 313, the face authentication unit 314, and the determination unit 315, may be realized in a form in which a logical functional block and a physical processing circuit (i.e., hardware) are mixed. In a case where at least a part of the image acquisition unit 311, the information acquisition unit 312, the tracking unit 313, the face authentication unit 314, and the determination unit 315 is a functional block, at least a part of the image acquisition unit 311, the information acquisition unit 312, the tracking unit 313, the face authentication unit 314, and the determination unit 315 may be realized by the arithmetic apparatus 31 executing a predetermined computer program.

The arithmetic apparatus 31 may acquire (in other words, may read) the predetermined computer program from the storage apparatus 32. The arithmetic apparatus 31 may read the predetermined computer program stored by a computer-readable, non-transitory recording medium, by using a not-illustrated recording medium reading apparatus provided in the information processing apparatus 3. The arithmetic apparatus 31 may acquire (in other words, may downloaded or read) the predetermined computer program from a not-illustrated apparatus external to the information processing apparatus 3, via the communication apparatus 33. At least one of an optical disk, a magnetic medium, a magneto-optical disk, a semi-conductor memory, and any other medium configured to store a program, may be used as the recording medium that records therein the predetermined computer program to be executed by the arithmetic apparatus 31.

The management server 21 transmits at least a part of the face image registered in the face DB 211 to the information processing apparatus 3, together with the authentication ID (i.e., the passenger identification information) added to the face image. In this instance, in addition to the face image, the management server 21 may transmit the gate identification information and the boarding start time to the information processing apparatus 3. The management server 21 may identify the gate identification information and the boarding start time, based on the flight number of the aircraft included in the passenger information associated with the face image registered in the face DB 211 and based on the operation information registered in the operation DB 212. That is, the management server 21 may identify the gate identification information and the boarding start time, relating to the aircraft that the passenger indicated by the face image goes aboard. In a case where the feature quantity relating to the face image is registered in the face DB 211 in place of or in addition to the face image, the management server 21 may transmit the feature quantity relating to the face image to the information processing apparatus 3 in place of or in addition to the face image.

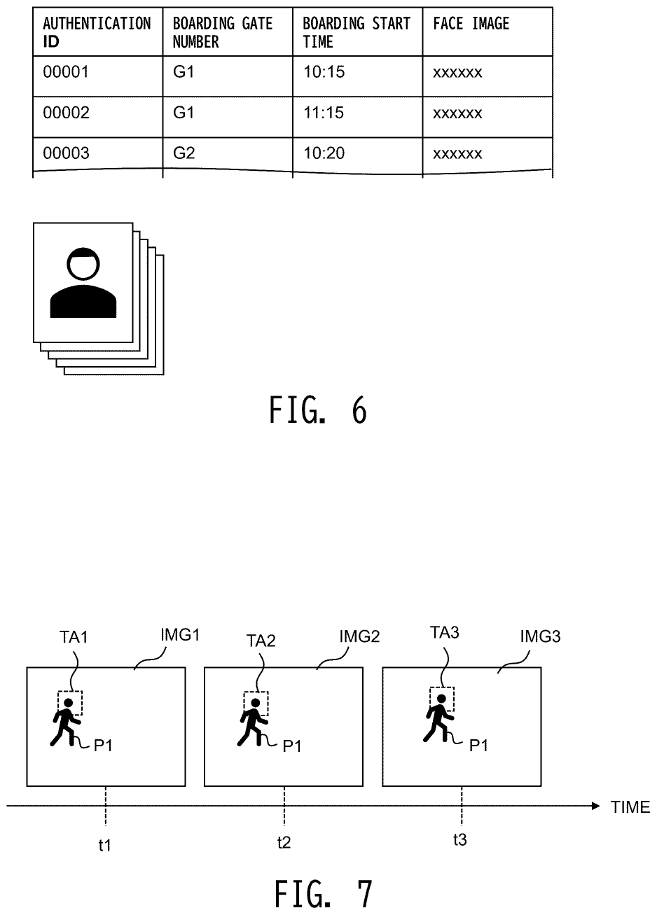

The information processing apparatus 3 registers, in the face DB36, the face image transmitted from the management server 21. In addition to the face image, the information processing apparatus 3 may register, in the face DB36, the gate identification information and the boarding start time. As illustrated in FIG. 6, the face DB36 may include (i) a plurality of face images, and (ii) a table that associates the authentication ID, the gate identification information (e.g., a boarding gate number), the boarding start time, and the face image with one another. The management server 21 may transmit at least a part of the face image registered in the face DB 211 to the information processing apparatus 3 in a predetermined cycle. The information processing apparatus 3 may update the face image registered in the face DB36 at each time when the face image is transmitted from the management server 21. In a case where the management server 21 transmits the feature quantity relating to the face image to the information processing apparatus 3 in place of or in addition to the face image, the feature quantity relating to the face image may be registered in the face DB36 in place of or in addition to the face image.

The image acquisition unit 311 of the arithmetic apparatus 31 may acquire one or more first images generated by the camera CAM via the communication apparatus 33. The image acquisition unit 311 may store the acquired one or more first images in the storage apparatus 32. The information acquisition unit 312 of the arithmetic apparatus 31 acquires the boarding gate information about the boarding gate G1 from the gate DB 213 of the management server 21, via the communication apparatus 33. The information acquisition unit 312 may store the acquired boarding gate information in the storage apparatus 32.

The information acquisition unit 312 of the arithmetic apparatus 31 acquires terminal position information indicating a position of each of the terminal apparatuses 41 and 42. The information acquisition unit 312 may acquire the terminal position information from each of the terminal apparatuses 41 and 42. In this case, the position of the terminal apparatus 41 may be detected by a position information function of the terminal apparatus 41. Similarly, the position of the terminal apparatus 42 may be detected by a position information function of the terminal apparatus 42.

The tracking unit 313 of the arithmetic apparatus 31 tracks one or more passengers passing through the authentication area RA, by using a plurality of first images acquired by the image acquisition unit 311 (i.e., a plurality of first images generated by the camera CAM). The face authentication unit 314 of the arithmetic apparatus 31 performs the face authentication processing on one or passengers passing through the authentication area RA, by using the plurality of first images acquired by the image acquisition unit 311.

With reference to FIG. 7, a case where the tracking unit 313 performs tracking processing of tracking a passenger P1 passing through the authentication area RA illustrated in FIG. 4 and the face authentication unit 314 performs the face authentication processing on the passenger P1, will be described. Since the passenger P1 is also a target person of the face authentication processing, it may be referred to as an authentication subject.

Images IMG1, IMG2 and IMG3 illustrated in FIG. 7 are images including the passenger P1 (in other words, images in which the passenger P1 is captured). The image IMG1 is an image generated by the camera CAM imaging the authentication area RA at a time t1. The image IMG2 is an image generated by the camera CAM imaging the authentication area RA at a time t2 that is after the time t1. The image IMG3 is an image generated by the camera CAM imaging the authentication area RA at a time t3 that is after the time t2.

Each of the images IMG1, IMG2 and IMG3 may be an image corresponding to one frame of a video. In such a case, the image IMG2 may not be an image corresponding to a frame immediately after a frame corresponding to the image IMG1. That is, the image IMG2 may be an image corresponding to a frame existing two or more frames after the frame corresponding to the image IMG1. Similarly, the image IMG3 may not be an image corresponding to a frame immediately after a frame corresponding to the image IMG2. That is, the image IMG3 may be an image corresponding to a frame existing two or more frames after the frame corresponding to the image IMG2.

The tracking unit 313 detects, from the image IMG1, a head of the passenger P1 included in the image IMG1. Since existing techniques/technologies are applicable to a method of detecting the human head from the image, a detailed description of the method will be omitted. The tracking unit 313 sets an area including the head of the passenger P1 as a tracking area TA1, based on the detected head of the passenger P1.

When setting the tracking area TA1, the tracking unit 313 sets, for the passenger P1, a tracking ID that is identification information for identifying the passenger P1 relating to the tracking area TA. The tracking unit 313 calculates a position of the passenger P1, based on the tracking area TA1. Since existing techniques/technologies are applicable to a method of calculating, from the image, the position of a subject included in the image, a detailed description of the method will be omitted. The tracking unit 313 may associate the tracking ID and the position of the passenger P1 with each other, and may register them in an ID correspondence table 321 stored in the storage apparatus 32.

When setting the tracking area TA1, the tracking unit 313 may determine whether or not the face of the passenger P1 is captured in the tracking area TA1. In other words, the tracking unit 313 may perform face detection for the tracking area TA1. When it is determined that the face of the passenger P1 is captured in the tracking area TA1, the tracking unit 313 generates a face image including a face area of the passenger P1. The tracking unit 313 transmits, to the face authentication unit 314, the generated face image in association with the tracking ID relating to the passenger P1. When it is determined that the face of the passenger P1 is not captured in the tracking area TA1, the tracking unit 313 may not generate the face image.

The face authentication unit 314 performs the face authentication processing, by using the face image transmitted from the tracking unit 313 and the face image registered in the face DB36. The face authentication unit 314 may extract the feature quantity of the face image transmitted from the tracking unit 313. The face authentication unit 314 may collate/verify the feature quantity of the face image transmitted from the tracking unit 313 with the feature quantity relating to the face image registered in the face DB36. At this time, the face authentication unit 314 may calculate a matching score (or a similarity score), based on the extracted feature quantity and the feature quantity relating to the face image registered in the face DB36. The face authentication unit 314 may compare the matching score with a threshold. When the matching score is greater than or equal to the threshold, the face authentication unit 314 may determine that the face indicated by the face image transmitted from the tracking unit 313 corresponds to the face indicated by one of the face images registered in the face DB36. When the matching score is less than the threshold, the face authentication unit 314 may determine that the face image indicating the face corresponding to the face indicated by the face image transmitted from the tracking unit 313 is not registered in the face DB36.

When the face indicated by the face image transmitted from the tracking unit 313 corresponds to the face indicated by one of the face images registered in the face DB36 (in other words, when the face authentication is successful), the face authentication unit 314 associates the authentication ID corresponding to one face image, with the tracking ID corresponding to the face image transmitted from the tracking unit 313, and registers it in the ID correspondence table 321. The face authentication unit 314 may register, in the ID correspondence table 321, an authentication time that is a time at which the face authentication processing is performed, in addition to the authentication ID.

When the face image indicating the face corresponding to the face indicated by the face image transmitted from the tracking unit 313 is not registered in the face DB36 (in other words, when the face authentication is failed), the face authentication unit 314 may associate information indicating that there is no applicable person (e.g., “N/A (Not Applicable)”), with the tracking ID corresponding to the face image transmitted from the tracking unit 313, and may register it in the ID correspondence table 321.

In this case, the face authentication unit 314 may register failure reason information indicating a reason for a failure in the face authentication, in the ID correspondence table 321. The reason for the failure in the face authentication may include a first reason indicating that the face authentication is failed because the image (e.g., the face image) is unsuitable for the face authentication, and a second reason indicating that the face authentication is failed even though the image (e.g., a face image) is suitable for the face authentication. The image that is unsuitable for the face authentication may include: an image in which the face of the passenger (e.g., passenger P1) is downturned or turned to the side, or a part of the face is hidden by an obstruction, and thus, the face area of the passenger included in the face image is unsuitable for the face authentication; a face image of the passenger differing from normal (in other words, the face is different from the face indicated by the face image registered in the face DB 36) (e.g., a face image including at least one of a beard, glasses, and a mask); and an image that is out of focus or blurred. A case of the second reason for the failure in the face authentication is a case where the face image indicating the face of the passenger (e.g., the passenger P1) subjected to the face authentication processing is not registered in the face DB 36.

The tracking unit 313 may identify the passenger P1 included in the image IMG2, by using the image IMG2 and the image IMG1. Identifying the passenger P1 included in the image IMG2 is synonymous with associating the passenger P1 included in the image IMG1 with the passenger P1 included in the image IMG2. Therefore, at least one of a matching method and an optical flow method relating to the association between the images, is applicable to the identification of the passenger P1 included in the image IMG2. Since various existing aspects are applicable to each of the matching method and the optical flow method, a detailed description of the methods will be omitted.

When the passenger P1 included in the image IMG2 is identified, the tracking unit 313 detects the head of the passenger P1. The tracking unit 313 sets the area including the head of the passenger P1, as a tracking area TA2, based on the detected head of the passenger P1. Since the passenger P1 included in the image IMG1 and the passenger P1 included in the image IMG2 are the same passenger, the tracking ID of the passenger P1 relating to the tracking area TA2 is the same as the tracking ID of the passenger P1 relating to the tracking area TA1. The tracking unit 313 calculates the position of the passenger P1, based on the tracking area TA2.

The tracking unit 313 registers, in the ID correspondence table 321, the position of the passenger P1 in association with the tracking ID relating to the passenger P1. In this instance, since the position of the passenger P1 calculated based on the tracking area TA1 is registered in the ID correspondence table 321, the position of the passenger P1 is updated, by the tracking unit 313 registering, in the ID correspondence table 321, the position of the passenger P1 calculated based on the tracking area TA2.

When setting the tracking area TA2, the tracking unit 313 may determine whether or not the face of the passenger P1 is captured in the tracking area TA2. In other words, the tracking unit 313 may perform the face detection for the tracking area TA2. When it is determined that the face of the passenger P1 is captured in the tracking area TA2, the tracking unit 313 generates a face image including the face area of the passenger P1. The tracking unit 313 transmits, to the face authentication unit 314, the generated face image in association with the tracking ID relating to the passenger P1. When it is determined that the face of the passenger P1 is not captured in the tracking area TA2, the tracking unit 313 may not generate the face image. Even when it is determined that the face of the passenger P1 is captured in the tracking area TA2, in a case where the tracking ID relating to the passenger P1 is associated with the authentication ID in the ID correspondence table 321 (i.e., in a case where the face authentication is successful), the tracking unit 313 may not generate the face image.

The face authentication unit 314 performs the face authentication processing, by using the face image transmitted from the tracking unit 313 and the face image registered in the face DB36. In a case where the face indicated by the face image transmitted from the tracking unit 313 corresponds to the face indicated by one of the face images registered in the face DB36 (in other words, in a case where the face authentication is successful), the face authentication unit 314 associates the authentication ID corresponding to one face image, with the tracking ID corresponding to the face image transmitted from the tracking unit 313, and registers it in the ID correspondence table 321. The face authentication unit 314 may register, in the ID correspondence table 321, an authentication time that is a time at which the face authentication processing is performed, in addition to the authentication ID. In a case where the authentication time is already registered in the ID correspondence table 321 (i.e., in a case where the face authentication was successful in the past), the face authentication unit 314 may update the authentication time registered in the ID correspondence table 321.

In a case where the face image indicating the face corresponding to the face indicated by the face image transmitted from the tracking unit 313 is not registered in the face DB36 (in other words, in a case where the face authentication is failed), the face authentication unit 314 may associate information indicating that there is no applicable person, with the tracking ID corresponding to the face image transmitted from the tracking unit 313, and may register it in the ID correspondence table 321. In this case, the face authentication unit 314 may register the failure reason information indicating the reason for the failure in the face authentication, in the ID correspondence table 321.

The tracking unit 313 may identify the passenger P1 included in the image IMG3 by using the image IMG3 and the image IMG2. When the passenger P1 included in the image IMG3 is identified, the tracking unit 313 detects the head of the passenger P1. The tracking unit 313 sets the area including the head of the passenger P1, as a tracking area TA3, based on the detected head of the passenger P1. Since the passenger P1 included in the image IMG2 and the passenger P1 included in the image IMG3 are the same passenger, the tracking ID of the passenger P relating to the tracking area TA3 is the same as the tracking ID of the passenger P relating to the tracking area TA2. The tracking unit 313 calculates the position of the passenger P1, based on the tracking area TA3.

The tracking unit 313 registers, in the ID correspondence table 321, the position of the passenger P1 in association with the tracking ID relating to the passenger P1. In this instance, since the position of the passenger P1 calculated based on the tracking area TA2 is registered in the ID correspondence table 321, the position of the passenger P1 is updated, by the tracking unit 313 registering, in the ID correspondence table 321, the position of the passenger P1 calculated based on the tracking area TA3.

When setting the tracking area TA3, the tracking unit 313 may determine whether or not the face of the passenger P1 is captured in the tracking area TA3. In other words, the tracking unit 313 may perform the face detection for the tracking area TA3. When it is determined that the face of the passenger P1 is captured in the tracking area TA3, the tracking unit 313 generates a face image including the face area of the passenger P1. The tracking unit 313 transmits, to the face authentication unit 314, the generated face image in association with the tracking ID relating to the passenger P1. When it is determined that the face of the passenger P1 is not captured in the tracking area TA3, the tracking unit 313 may not generate the face image. Even when it is determined that the face of the passenger P1 is captured in the tracking area TA3, in a case where the tracking ID relating to the passenger P1 is associated with the authentication ID in the ID correspondence table 321 (i.e., in a case where the face authentication is already successful), the tracking unit 313 may not generate the face image.

The face authentication unit 314 performs the face authentication processing, by using the face image transmitted from the tracking unit 313 and the face image registered in the face DB36. In a case where the face indicated by the face image transmitted from the tracking unit 313 corresponds to the face indicated by one of the face images registered in the face DB36 (in other words, in a case where the face authentication is successful), the face authentication unit 314 associates the authentication ID corresponding to one face image, with the tracking ID corresponding to the face image transmitted from the tracking unit 313, and registers it in the ID correspondence table 321. The face authentication unit 314 may register, in the ID correspondence table 321, an authentication time that is a time at which the face authentication processing is performed, in addition to the authentication ID. In a case where the authentication time is already registered in the ID correspondence table 321 (i.e., in a case where the face authentication was successful in the past), the face authentication unit 314 may update the authentication time registered in the ID correspondence table 321.

In a case where the face image indicating the face corresponding to the face indicated by the face image transmitted from the tracking unit 313 is not registered in the face DB36 (in other words, in a case where the face authentication is failed), the face authentication unit 314 may associate information indicating that there is no applicable person, with the tracking ID corresponding to the face image transmitted from the tracking unit 313, and may register it in the ID correspondence table 321. In this case, the face authentication unit 314 may register the failure reason information indicating the reason for the failure in the face authentication, in the ID correspondence table 321.

The tracking unit 313 and the face authentication unit 314 may repeat the above-described processing, until the passenger P1 passes through the authentication area RA. The tracking unit 313 calculates the position of the passenger P1 as described above. That is, it can be said that the tracking unit 313 detects the position of the passenger P1. Therefore, the tracking unit 313 may be referred to as a position detection unit.

Referring now to FIG. 8, an example of the ID correspondence table 321 will be described. As illustrated in FIG. 8, in the ID correspondence table 321, the tracking ID, a tracking position (e.g., the position of the passenger P1), the authentication ID, and the authentication time may be associated with each other. In the ID correspondence table 321, a case where the tracking ID is associated with a specific authentication ID, indicates that the face image of a person corresponding to the passenger having a set tracking ID is registered in the face DB36. A case where the tracking ID is associated with a character string of “N/A”, indicates that the face image of a person corresponding to the passenger having a set tracking ID is not registered in the face DB36. A case where the tracking ID is not associated with the authentication ID (i.e. a case where a field of the authentication ID is blank), indicates that the face authentication processing is not performed even once.

By the way, in some cases, it is hard for the tracking unit 313 to continue tracking the passenger P1, for example, as the head of the passenger P1 is hidden behind others. When the tracking of the passenger P1 is lost, the tracking unit 313 may perform the following processing. After losing the tracking of the passenger P1, the tracking unit 313 may determine whether or not a new passenger is detected from the first image acquired by the image acquisition unit 311 (i.e., the first image generated by the camera CAM). The “new passenger” means a passenger whose tracking ID is not set.

When the new passenger is detected, the tracking unit 313 may determine whether or not the passenger P1 and the new passenger are the same person, by comparing the feature quantity of the tracking area relating to the passenger P1 (e.g., at least one of the tracking areas TA1, TA2 and TA3) with the feature quantity of the tracking area relating to the new passenger. When the passenger P1 and the new passenger are determined to be the same person, the tracking unit 313 may set the tracking ID relating to the passenger P1, for the new passenger. Consequently, the tracking unit 313 may track the passenger P1 again. Note that the feature quantity may be a feature quantity relating to the head of the passenger, a feature quantity relating to an upper body of the passenger, or a feature quantity relating to an entire body of the passenger. Accordingly, the tracking area may include the head of the passenger, may include the upper body of the passenger, or may include the entire body of the passenger. The feature quantity may be determined, for example, by a Person Re-Identification technique/technology.

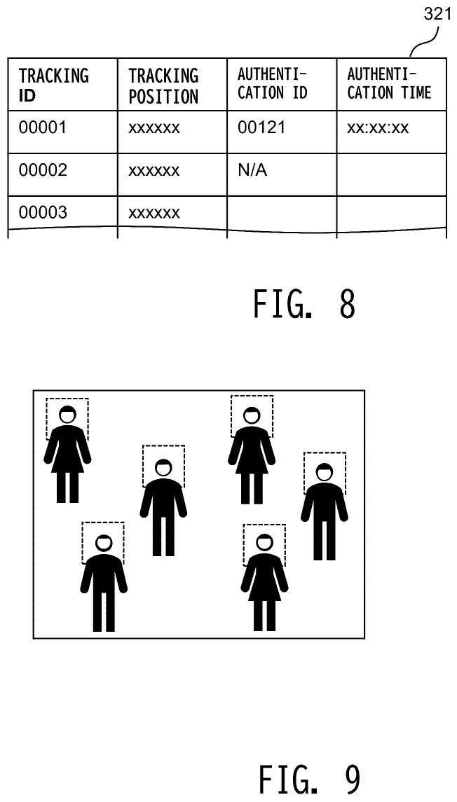

The tracking unit 313 and the face authentication unit 314 may perform the above-described tracking processing and the face authentication processing, on each of the plurality of passengers included in the first image generated by the camera CAM. Here, the authentication area RA may be, for example, an area of 5 meters by 5 meters. A distance of 5 meters is long enough for 5 to 6 passengers to be permitted to pass side by side. In a case where the authentication area RA is an area of 5 meters by 5 meters, there may be 20 to 30 passengers in the authentication area RA. Therefore, the information processing apparatus 3 is configured to perform the tracking processing and the face authentication processing on the plurality of passengers, based on one first image generated by the camera CAM as illustrated in FIG. 9. Incidentally, a plurality of dotted rectangles in FIG. 9 represent the tracking area.

The tracking area (e.g., at least one of the tracking areas TA1, TA2 and TA3) may include a part other than the head of the passenger (e.g., a shoulder), in addition to the head of the passenger (e.g., the passenger P1) subjected to the tracking processing performed by the tracking unit 313. The tracking area may be set to include the upper body of the passenger, or may be set to include the entire body of the passenger.

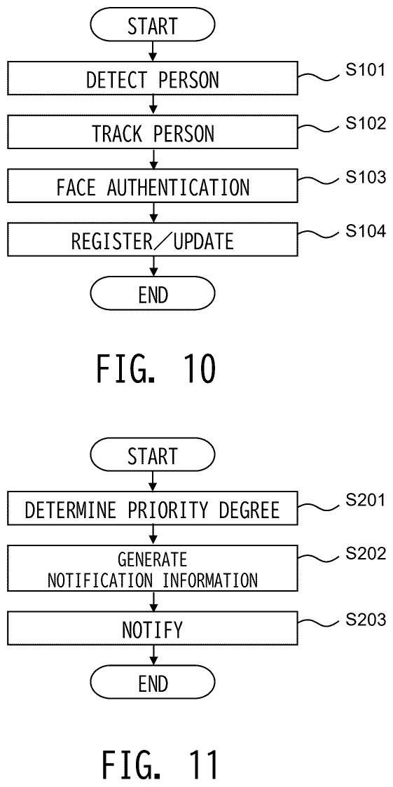

The operation of the tracking unit 313 and the face authentication unit 314 will be described with reference to a flowchart in FIG. 10. In FIG. 10, the tracking unit 313 detects one or more passengers (i.e., persons), from the first image acquired by the image acquisition unit 311 (i.e., the first image generated by the camera CAM) (step S101). In the step S101, the tracking unit 313 may detect the head of the passenger. In the step S101, the tracking unit 313 may set the tracking area including the head of the passenger detected, based on the head of the passenger detected. In the step S101, the tracking unit 313 may perform the face detection on the detected one or more passengers.

The tracking unit 313 performs the tracking processing on at least one of the one or more passengers detected in the step S101, by using another first image acquired by the image acquisition unit 311 (step S102). In the step S102, the tracking unit 313 may perform the face detection on the detected one or more passengers. In at least one of the steps S101 and S102, in a case where the face of at least one of the one or more passengers is detected, the tracking unit 313 transmits the face image including the face area of the at least one passenger, to the face authentication unit 314.

The face authentication unit 314 performs the face authentication processing by using the face image transmitted from the tracking unit 313 (step S103). The face authentication unit 314 registers a result of the face authentication processing in the ID correspondence table 321, or updates the ID correspondence table 321 based on the result of the face authentication processing (step S104).

Next, the operation of the determination unit 315 of the arithmetic apparatus 31 will be described. Here, a passenger P2 is used as an example. The determination unit 315 may determine whether or not the passenger P2 is permitted to pass through the face authentication gate apparatus 23, based on the ID correspondence table 321. In the ID correspondence table 321, in a case where the tracking ID relating to the passenger P2 is associated with a specific authentication ID, the determination unit 315 may determine that “there is an applicable person” for the passenger P2. In the ID correspondence table 321, in a case where the tracking ID relating to the passenger P2 is associated with the character string of “N/A”, the determination unit 315 may determine that “there is no applicable person” for the passenger P2. In a case where the tracking ID relating to the passenger P2 is not associated with the authentication ID (i.e., in a case where a field of the authentication ID is blank), the determination unit 315 may determine that the passenger P2 is “unauthenticated”.

In a case where the failure reason information is registered in the ID correspondence table 321, the determination unit 315 may make the following determination. In a case where the tracking ID relating to the passenger P2 is associated with the character string of “N/A” and the failure reason information is the second reason (i.e., the reason indicating that the face authentication is failed even though the image is suitable for the face authentication), the determination unit 315 may determine that “there is no applicable person” for the passenger P2. In a case where the tracking ID relating to the passenger P2 is associated with the character string of “N/A” and the failure reason information is the first reason (i.e., the reason indicating that the face authentication is failed because the image is unsuitable for the face authentication), the determination unit 315 may determine that the passenger P2 is “unauthenticated”.

In a case where it is determined that “there is an applicable person” for the passenger P2, the determination unit 315 may determine whether or not the passenger P2 is permitted to pass through the face authentication gate apparatus 23, based on the authentication ID of the passenger P2 and the face DB 36. For example, the determination unit 315 may determine whether or not the boarding gate number (see FIG. 6) associated with the authentication ID in the face DB 36 matches the boarding gate number of the boarding gate at which the face authentication gate apparatus 23 is disposed. When the boarding gate number associated with the authentication ID does not match the boarding gate number of the boarding gate at which the face authentication gate apparatus 23 is disposed, the determination unit 315 may determine that the passenger is not permitted to pass through the face authentication gate apparatus 23. When it is determined that the boarding gate number associated with the authentication ID matches the boarding gate number of the boarding gate at which the face authentication gate apparatus 23 is disposed, the determination unit 315 may determine that the passenger is permitted to pass through the face authentication gate apparatus 23. Alternatively, when it is determined that the boarding gate number associated with the authentication ID matches the boarding gate number of the boarding gate at which the face authentication gate apparatus 23 is disposed, the determination unit 315 may compare the boarding start time associated with the authentication ID in the face DB 36 with the current time, and may determine whether or not the passenger can pass through the face authentication gate unit 23 may determine whether or not the passenger is permitted to pass through the face authentication gate apparatus 23.

As illustrated in FIG. 3, the face authentication gate apparatus 23 is disposed at the boarding gate G1. In a case where the boarding gate of the aircraft that the passenger P2 goes aboard is not the boarding gate G1, the determination unit 315 may determine that the passenger P2 is not permitted to pass through the face authentication gate apparatus 23. In a case where the boarding gate of the aircraft that the passenger P2 goes aboard is the boarding gate G1, but the current time is a second predetermined time (e.g., ten to several tens of minutes) or more before the boarding start time, the determination unit 315 may determine that the passenger P2 is not permitted to pass through the face authentication gate apparatus 23. In a case where the boarding gate of the aircraft that the passenger P2 goes aboard is the boarding gate G1 and the current time is not the second predetermined time or more before the boarding start time, the determination unit 315 may determine that the passenger P2 is permitted to pass through the face authentication gate unit 23.

The determination unit 315 may output, as a determination result for the passenger P2, any one of (i) a first determination result indicating that there is an applicable person and the passenger P2 is permitted to pass through the face authentication gate unit 23, (ii) a second determination result indicating that there is an applicable person, but the passenger P2 is not permitted to pass through the face authentication gate unit 23, (iii) a third determination result indicating that there is no applicable person, and (iv) a fourth determination result indicating that the passenger P2 is unauthenticated. That is, the determination unit 315 may classify the plurality of passengers into any one of a first type corresponding to the first determination result, a second type corresponding to the second determination result, a third type corresponding to the third determination result, and a fourth type corresponding to the fourth determination result. It can be said that the third and fourth types indicate the failure in the face authentication. The result of the determination by the determination unit 315 is based on the result of the face authentication processing performed by the face authentication unit 314. Therefore, the result of the determination by the determination unit 315 may be rephrased as the result of the face authentication processing or the authentication result. Since the determination unit 315 classifies the passenger by determining the type of the passenger, the determination unit 315 may be referred to as a type determination unit.

The determination unit 315 determines the priority degree of the determination result relating to the passenger P2, on the basis of: the type relating to the passenger P2 based on the determination result; and the position of each of the terminal apparatuses 41 and 42 indicated by the terminal position information. The determination unit 315 may determine whether or not to transmit the determination result relating to the passenger P2 to at least one of the terminal apparatuses 41 and 42, based on the determined priority degree. Alternatively, the determination unit 315 may determine whether or not to preferentially transmit the determination result relating to the passenger P2 to at least one of the terminal apparatuses 41 and 42, based on the determined priority degree.

A method of determining the priority degree by the determination unit 315 (in other words, a rule or reference for prioritization) is arbitrary. An example of the method of determining the priority degree by the determination unit 315 is described below. When the priority degree of the determination result is higher than the reference, the determination result is assumed to be transmitted to at least one of the terminal apparatuses 41 and 42, and when the priority degree of the determination result is lower than the reference, the determination result is assumed to be not transmitted to the terminal apparatuses 41 and 42. A case where the priority degree and the reference are “equal,” may be included in either one of the two cases. The priority degree may be expressed as a numerical value or as a category (e.g., high, medium, low).

In order that the determination result relating to a first type of passenger (i.e., a passenger for whom it is determined that there is an applicable person and who is determined to be permitted to pass through the face authentication gate unit 23) is not transmitted to the terminal apparatuses 41 and 42, the determination unit 315 may set the priority degree of the determination result to be lower than the reference.

In order that the determination results relating to a second type of passenger (i.e., a passenger for whom it is determined that there is an applicable person, but who is determined to be not permitted to pass through the face authentication gate unit 23), a third type of passenger (i.e., a passenger for whom it is determined that there is no applicable person), and a fourth type of passenger (i.e., a passenger who is determined to be unauthenticated) are transmitted to the terminal apparatuses 41 and 42, the determination unit 315 may set the priority degrees of the determination results to be higher than the reference. That is, in order that the determination result relating to the passenger who is not permitted to pass through the face authentication gate unit 23 is transmitted to at least one of the terminal apparatuses 41 and 42, the determination unit 315 may set the priority degree of the determination results to be higher than the reference.

The determination unit 315 may set the priority degree of the determination result relating to the second type of passenger among the determination results transmitted to the terminal apparatus 41, to be lower than the priority degree of the determination result relating to the third type of passenger and the priority degree of the determination result relating to the fourth type of passenger. The priority degree of the determination result relating to the second type of passenger is higher than the reference. In this case, the determination unit 315 may set the priority degree of the determination result relating to the third type of passenger to be higher than the priority degree of the determination result relating to the fourth type of passenger.

The determination unit 315 may set the priority degree of the determination result relating to the second type of passenger among the determination results transmitted to the terminal apparatus 42, to be higher than the priority degree of the determination result relating to the third type of passenger and the priority degree of the determination result relating to the fourth type of passenger. The priority degree of the determination result relating to the third type of passenger and the priority degree of the determination result relating to the fourth type of passenger are higher than the reference. In this case, the determination unit 315 may set the priority degree of the determination result relating to the third type of passenger to be higher than the priority degree of the determination result relating to the fourth type of passenger.

Even when the failure reason information is registered in the ID correspondence table 321, in a case where the tracking ID relating to the passenger P2 is associated with the character string of “N/A,” the determination unit 315 may determine that “that is no applicable person” for the passenger P2, regardless of the failure reason information (i.e., the passenger P2 may be determined to be the third type of passenger). In this case, the determination unit 315 may determine the priority degree of the determination result relating to the passenger P2, based on the failure reason information. The determination unit 315 may set the priority degree of the determination result relating to the passenger P2 when the failure reason information indicates the first reason (i.e., the reason indicating that the face authentication is failed because the image is unsuitable for the face authentication), to be lower than the priority degree of the determination result relating to the passenger P2 when the failure reason information indicates the second reason (i.e., the reason indicating that the face authentication is failed even though the image is suitable for the face authentication).

As illustrated in FIG. 4, a distance between the terminal apparatus 41 and the face authentication gate apparatus 23 and a distance between the terminal apparatus 42 and the face authentication gate apparatus 23 are different from each other. Therefore, it can be said that the determination unit 315 may determine (or change) the priority degree of the determination result relating to the passenger described above, on the basis of: the type relating to the passenger (e.g., the passenger P2) based on the determination result; and a positional relation between the terminal apparatus 41 or 42 and the face authentication gate apparatus 23.

For example, a distance from the face authentication gate apparatus 23 to an edge on a side of the face authentication gate apparatus 23 of the authentication area RA is assumed to be a predetermined distance. In FIG. 4, it can be said that the distance between the terminal apparatus 41 and the face authentication gate apparatus 23 is shorter than the predetermined distance. On the other hand, it can be said that the distance between the terminal apparatus 41 and the face authentication gate apparatus 23 is longer than the predetermined distance.

As described above, the determination unit 315 may set the priority degree of the determination result relating to the second type of passenger among the determination results transmitted to the terminal apparatus 41, to be lower than the priority degree of the determination result relating to the third type of passenger and the priority degree of the determination result relating to the fourth type of passenger. That is, it can be said that, when the distance between the terminal apparatus 41 and the face authentication gate apparatus 23 is shorter than the predetermined distance and the type relating to the passenger is the third type or the fourth type, the determination unit 315 may set the priority degree of the determination result relating to the passenger, to be higher than the priority degree when the distance between the terminal apparatus 41 and the face authentication gate apparatus 23 is shorter than the predetermined distance and the type relating to the passenger is the second type.

As described above, the determination unit 315 may set the priority degree of the determination result relating to the second type of passenger among the determination results transmitted to the terminal apparatus 42, to be higher than the priority degree of the determination result relating to the third type of passenger and the priority degree of the determination result relating to the fourth type of passenger. That is, it can be said that, when the distance between the terminal apparatus 42 and the face authentication gate apparatus 23 is longer than the predetermined distance and the type relating to the passenger is the second type, the determination unit 315 may set the priority degree of the determination result relating to the passenger, to be higher than the priority degree when the distance between the terminal apparatus 42 and the face authentication gate apparatus 23 is longer than the predetermined distance and the type relating to the passenger is the third type or the fourth type.

The operation of the determination unit 315 will be described with reference to a flowchart in FIG. 11. In FIG. 11, the determination unit 315 determines the priority degree of each of the plurality of determination results respectively corresponding to the plurality of passengers (step S201). The determination unit 315 generates information to be transmitted to at least one of the terminal apparatuses 41 and 42, based on the determined priority degree and the plurality of determination results (step S202). The determination unit 315 transmits the information generated in the step S202 to at least one of the terminal apparatuses 41 and 42 via the communication apparatus 33. As a result, the information transmitted to at least one of the terminal apparatuses 41 and 42 is displayed on at least one of the terminal apparatuses 41 and 42, thereby notifying at least one of the staff members A1 and A2 of the information (step S203). In this case, the terminal apparatuses 41 and 42 may determine a display order of notification information, based on the priority degree determined by the determination unit 315.

At least one of the staff members A1 and A2 is notified of the information transmitted from the determination unit 315 to at least one of the terminal apparatuses 41 and 42 via the communication apparatus 33, by the information being displayed on at least one of the terminal apparatuses 41 and 42. Therefore, the information generated by the determination unit 315 in the step S202 may be referred to as notification information. The information generated by the determination unit 315 in the step S202 will be hereinafter referred to as “notification information” as appropriate.

The notification information may include information indicating the determination result, and information indicating the priority degree of the determination result. The notification information may include the information indicating the determination result, the information indicating the priority degree of the determination result, and the image of the passenger detected by the tracking unit 313 from the first image (i.e., the first image generated by the camera CAM). In a case where the determination result is the determination result relating to the second type of passenger, the determination unit 315 may include the information indicating the determination result, the information indicating the priority degree of the determination result, and information about the second type of passenger (e.g., at least one of the name, the face image, and the boarding gate number), in the notification information.

For example, FIG. 12 illustrates an example of a window/screen of the terminal apparatus 42 when the notification information transmitted from the determination unit 315 is displayed on the terminal apparatus 42. In FIG. 12, images 421, 422 and 423 including human figures represent images including passengers (i.e., authentication subjects). The images 421, 422 and 423 (i.e., the images including the passengers) may be images obtained by imaging entire bodies of the passengers. Such images may be extracted from the first image generated by the camera CAM. The image including the passenger may be the face image used in the face authentication processing by the face authentication unit 314, or may be a symbol (e.g., an icon) indicating a person. Dashed border lines surrounding the images 421 and 422 indicate that the type of the passenger is the second type (i.e., the passenger for whom it is determined that there is an applicable person, but who is determined to be not permitted to pass through the face authentication gate unit 23). A solid border lines surrounding the image 423 indicates that the type of the passenger is the third type (i.e., the passenger for whom it is determined that there is no applicable person) or the fourth type (i.e., the passenger who is determined to be unauthenticated).

In a case where the notification information generated by the determination unit 315 includes the information about the second type of passenger, the terminal apparatus 42 may display the passenger's name and a specific guiding destination on the screen, based on the information about the second type of passenger (see a dotted circle Cl in FIG. 12). The terminal apparatus 42 may set the normal gate apparatus as the specific guiding destination for the third type of passenger and the fourth type of passenger.

As described above, the determination unit 315 may set the priority degree of the determination result relating to the second type of passenger among the determination results transmitted to the terminal apparatus 42, to be higher than the priority degree of the determination result relating to the third type of passenger and the priority degree of the determination result relating to the fourth type of passenger. The terminal apparatus 42 may determine or change a display order of the determination results, based on the priority degrees of the determination results. The terminal apparatus 42 may generate display information to be displayed on the screen, based on the determined or changed display order of the determination results. As a result, the terminal apparatus 42 displays the information about the second type of passenger, in preference to information about the third type or fourth type of passenger.

For example, the staff member A2 may recognize the passenger to be preferentially supported, based on the information displayed on the terminal apparatus 42. When the support for the passenger is completed (e.g., when the passenger has been guided to an appropriate gate apparatus), the staff member A2 may tap a button of “Guiding Completed” (see FIG. 12) displayed on the terminal apparatus 42. As a result, the terminal apparatus 42 may update the screen such that the information about the passenger for whom the button of “Guiding Completed” is tapped disappears from the screen (in other words, may change the display information displayed on the screen). The terminal apparatus 42 may further transmit, to information processing apparatus 3, information indicating the passenger supported by the staff member A2 (e.g., the tracking ID relating to the passenger). The information processing apparatus 3, which has received the information indicating the passenger supported by the staff member A2 from the terminal apparatus 42, may delete the information about the passenger indicated by the received information, from the ID correspondence table 321.

An example of the screen of the terminal apparatus 42 is described above with reference to FIG. 12. The same may apply to the terminal apparatus 41. The determination unit 315, however, may set the priority degree of the determination result relating to the third type of passenger and the priority degree of the determination result relating to the fourth type of passenger among the determination results transmitted to the terminal apparatus 41, to be higher than the priority degree of the determination result relating to the second type of passenger. The terminal apparatus 41 may determine or change the display order of the determination results, based on the priority degrees of the determination results. The terminal apparatus 41 may generate the display information to be displayed on the screen, based on the determined or changed display order of the determination results. As a result, the terminal apparatus 41 displays the information about the third type or fourth type of passenger, in preference to the information about the passengers of the second type.

The operation of the information processing apparatus 3 described above may be realized by the information processing apparatus 3 reading a computer program recorded on a recording medium. In this case, it can be said that a computer program that allows the information processing apparatus 3 to perform the above-described operation is recorded on the recording medium.

### (Technical Effect)

In the information processing apparatus 3, the priority degree of at least a part of the plurality of determination results respectively corresponding to the plurality of passengers is determined, based on the types of the plurality of passengers and based on the position of the terminal apparatus (e.g., at least one of the terminal apparatuses 41 and 42). Therefore, according to the information processing apparatus 3, the airport staff (e.g., at least one of the staff members A1 and A2) carrying the terminal apparatus is notified of the determination result with a high priority degree. As a result, the airport staff can easily recognize the passenger to be preferentially supported. For example, the airport staff can easily recognize (or extract) the passenger not being permitted to pass through the face authentication gate apparatus 23. If the airport staff preferentially supports the person not being permitted to pass through the face authentication gate apparatus, it is possible to prevent/control the passenger not being permitted to pass through the face authentication gate apparatus 23 from entering the face authentication gate apparatus 23. Thus, according to the information processing apparatus 3, it is possible to prevent/control the reduction in the throughput of the face authentication gate apparatus.

In addition to the boarding gate at the airport, the information processing apparatus 3 may be applied to at least one of a security gate at the airport (i.e., a gate disposed in a security inspection site at the airport) and an immigration gate, for example. In addition to the airport, the information processing apparatus 3 may be applied to at least one of offices, railroad stations, theme parks, and event venues using the face authentication gate apparatus for at least one of entrance and exit, for example.

### (First Modification)

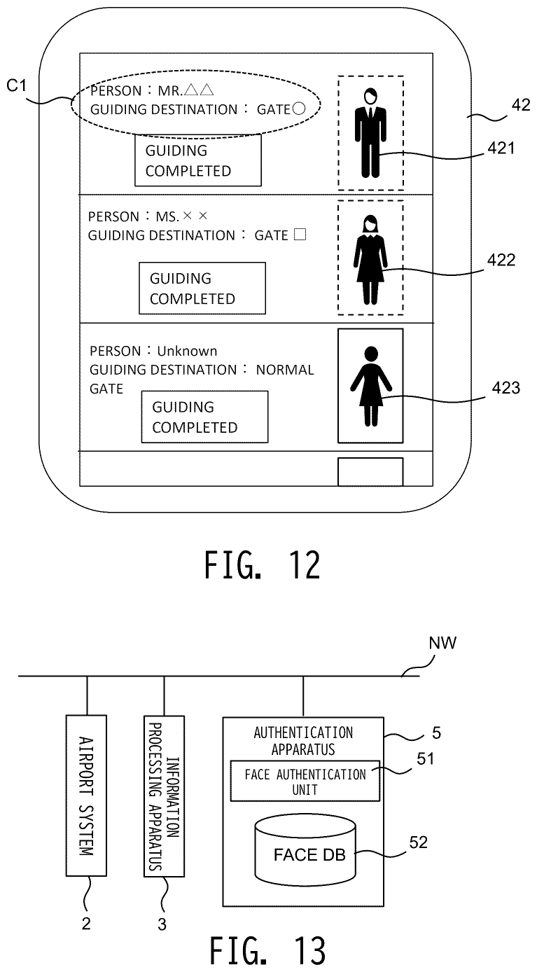

In the second example embodiment described above, the information processing apparatus 3 (specifically, the face authentication unit 314) performs the face authentication processing. The information processing apparatus 3, however, may not perform the face authentication processing. In this case, the information processing apparatus 3 may not include the face authentication unit 314 and the face DB 36. In this case, the face authentication processing may be performed by an authentication apparatus 5 differing from the information processing apparatus 3. In this case, as illustrated in FIG. 13, the information processing apparatus 3 and the authentication apparatus 5 may be connected via the network NW. The information processing apparatus 3 and the authentication apparatus 5 may constitute one system. The one system may be referred to as an information processing system or an authentication system. At least one of the terminal apparatuses 41 and 42 may also constitute a part of the above system. In other words, the above system may include the information processing apparatus 3, the authentication apparatus 5, and the terminal apparatuses 41 and 42.

The authentication apparatus 5 includes a face authentication unit 51 and a face database 52 (hereinafter referred to as a “face DB52”). The face authentication unit 51 is configured to perform the face authentication processing. That is, the authentication apparatus 5 is an authentication apparatus having a face authentication function. The management server 21 of the airport system 2 may transmit, to the authentication apparatus 5, at least a part of the face image registered in the face DB 211, together with the authentication ID (i.e., the passenger identification information) added to the face image. In this instance, the management server 21 may transmit the gate identification information and the boarding start time to the authentication apparatus 5, in addition to the face image. The authentication apparatus 5 may register, in the face DB52, the face image transmitted from the management server 21. In addition to the face image, the authentication apparatus 5 may register, in the face DB52, the gate identification information and the boarding start time.

The tracking unit 313 of the information processing apparatus 3 may detect the passenger (e.g., the passenger P1) included in the image acquired by the image acquisition unit 311. The tracking unit 313 may set the tracking area including the head of the passenger detected. The tracking unit 313 may perform the face detection on the detected passenger. In a case where the face of the passenger is detected, the tracking unit 313 may transmit the face image including the face area of the passenger, to the authentication apparatus 5 via the communication apparatus 33.

The face authentication unit 51 of the authentication apparatus 5 may perform the face authentication processing, by using the face image transmitted from the information processing apparatus 3 (specifically, the tracking unit 313) and the face DB52. The face authentication unit 51 may transmit information indicating a result of the face authentication processing, to the information processing apparatus 3. The information processing apparatus 3 may register, in the ID correspondence table 321, the result of the face authentication processing indicated by the information transmitted from the authentication apparatus 5 (specifically, the face authentication unit 51).

### (Second Modification)

The tracking unit 313 may identify the position of the passenger, based on the tracking ID relating to the passenger who is determined to be unauthenticated by the determination unit 315 (i.e., the fourth type of passenger). In a case where the passenger is located in a line/queue formed by passengers waiting to pass through the face authentication gate unit 23 (i.e., in a case where the passenger is in the line), the tracking unit 313 may perform the face detection on the above passenger by using a plurality of first images (i.e., a plurality of first images generated by the camera CAM). In this case, the tracking unit 313 may set the frequency of face detection of the above passenger, to be higher than that of another passenger. In this configuration, it is possible to set the frequency at which the face authentication unit 314 performs the face authentication processing on the above passenger, to be relatively high.

Alternatively, in a case where the failure reason information is registered in the ID correspondence table 321, the tracking unit 313 may identify the position of the passenger, based on the tracking ID relating to the passenger for whom the failure reason information indicates the first reason (i.e., the reason indicating that the face authentication is failed because the image is unsuitable for the face authentication). In a case where the passenger is located in the line formed by passengers waiting to pass through the face authentication gate unit 23 (i.e., in a case where the passenger is in the line), the tracking unit 313 may perform the face detection on the above passenger, by using the plurality of first images (i.e., the plurality of first images generated by the camera CAM). In this case, the tracking unit 313 may set the frequency of face detection of the above passenger, to be higher than that of another passenger. In this configuration, it is possible to set the frequency at which the face authentication unit 314 performs the face authentication processing on the above passenger, to be relatively high. That is, it can be said that the face authentication unit 314 may repeat the face authentication processing by using the plurality of first images, for the passenger for whom the failure reason information indicates the first reason.

### (Third Modification)

The determination unit 315 may determine (change) the priority degree such that, among the determination results transmitted to the terminal unit 41 (e.g., the determination results of the passengers who are determined not to be permitted to pass through the face authentication gate unit 23), the determination results of the passengers closer to the face authentication gate unit 23 have higher priority degrees.

### (Fourth Modification)

The determination unit 315 may determine the priority degree of the determination results (specifically, the determination results relating to the second type of passenger, the third type of passenger, and the fourth type of passenger) to be transmitted to at least one of the terminal apparatuses 41 and 42, to be one of “high” and “low”. That is, the determination unit 315 may classify the priority degree into two types. The determination unit 315 may classify the priority degree into three or more types. The determination unit 315 may calculate the priority degree as a numerical value.

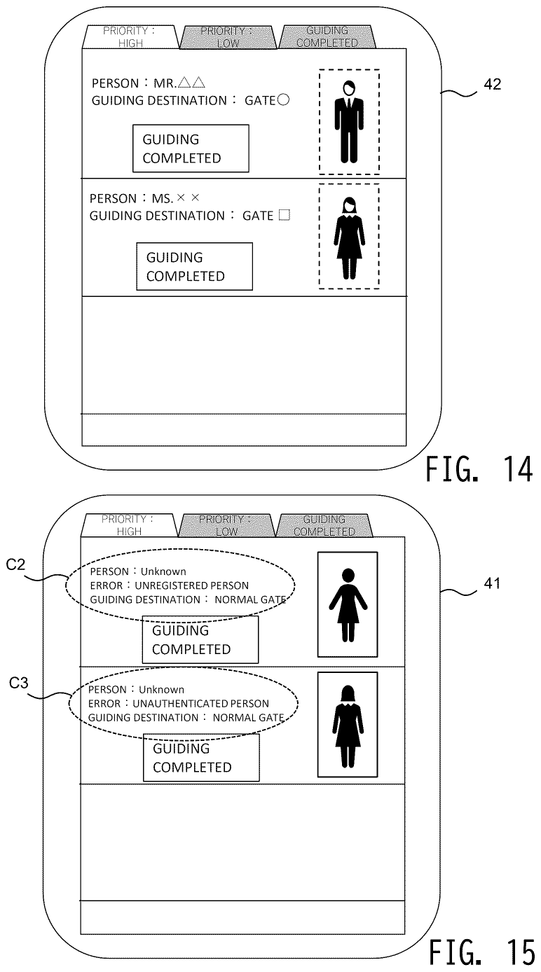

The priority degree of the determination result included in the notification information transmitted from the determination unit 315 is assumed to be one of the “high” priority degree and the “low” priority degree. In this case, as illustrated in FIG. 14, the terminal apparatus 42 may display the notification information transmitted from the determination unit 315, for each priority degree, by using a tab display function. As described above, the determination unit 315 may set the priority degree of the determination result relating to the second type of passenger among the determination results transmitted to the terminal apparatus 42 (in other words, the notification information), to be higher than the priority degree of the determination result relating to the third type of passenger and the priority degree of the determination result relating to the fourth type of passenger. That is, the determination unit 315 may determine the priority degree of the determination result relating to the second type of passenger, to be the “high” priority degree. The determination unit 315 may determine the priority degree of the determination result relating to the third type of passenger and the priority degree of the determination result relating to the fourth type of passenger, to be the priority degree “low”. Therefore, the terminal apparatus 42 may display the information about the second type of passenger, in a tab of “Priority degree: High”. The terminal apparatus 42 may display the information about the third type of passenger and the information about the fourth type of passenger, in a tab of “Priority degree: low” (not illustrated).

As illustrated in FIG. 15, the terminal apparatus 41 may display the notification information transmitted from the determination unit 315, for each priority degree, by using the tab display function. As described above, the determination unit 315 may set the priority degree of the determination result relating to the third or fourth type of passenger among the determination results transmitted to the terminal apparatus 41 (in other words, the notification information), to be higher than the priority degree of the determination result relating to the second type of passenger. That is, the determination unit 315 may determine the priority degree of the determination result relating to the third type of passenger and the priority degree of the determination result of the fourth type of passenger, to be the “high” priority degree. The determination unit 315 may determine the priority degree of the determination result relating to the second type of passenger to be the “low” priority degree. Therefore, the terminal apparatus 41 may display the information about the third or fourth type of passenger in the tab of “Priority degree: High”. The terminal apparatus 41 may display the information about the second type of passenger in the tab of “Priority degree: low” (not illustrated).

In the notification information transmitted from the determination unit 315, the failure reason information may be included in the determination result relating to the third type of passenger (i.e., the determination result indicating that there is no applicable person). When displaying the information about the third type of passenger, the terminal apparatus 41 may display the reason for the failure in the face authentication on the screen, based on the failure reason information. In a case where the determination result relating to the third type of passenger includes the failure reason information indicating the first reason (the reason indicating that the face authentication is failed because the image is unsuitable for the face authentication), the terminal apparatus 41 may include a description of “Error: unauthenticated person” in the information about the third type of passenger (see a dotted circle C3 in FIG. 15). In a case where the determination result relating to the third type of passenger includes the failure reason information indicating the second reason (the reason indicating that the face authentication is failed even though the image is suitable for the face authentication), the terminal apparatus 41 may include a description of “Error: unregistered person” in the information about the third type of passenger (see a dotted circle C2 in FIG. 15). The terminal apparatus 41 may also include the description of “Error: unregistered person” in the information about the fourth type of passenger.

The terminal apparatuses 41 and 42 may display information about the passenger for whom the support by one of the staff members A1 and A2 is completed, in a tab of “Guiding Completed”. When the button of “Guiding Completed” is tapped by one of the staff members A1 and A2, one of the terminal apparatuses 41 and 42 may transmit, to the information processing apparatus 3, status information indicating a situation/status (i.e., guiding completed) of the passenger for whom the button of “Guiding Completed” is tapped. The status information may include the tracking ID relating to the passenger, and information indicating “Guiding Completed”. The information processing apparatus 3, which has received the status information from one of the terminal apparatuses 41 and 42, may transmit information corresponding to the received status information, to the other of the terminal apparatuses 41 and 42. The other of the terminal apparatuses 41 and 42 may display information about the corresponding passenger in the tab of “Guidance Complete”, based on the information received from the information processing apparatus 3. As a result, the staff members A1 and A2 can share the passenger for whom the guiding is completed.

### (Fifth Modification)

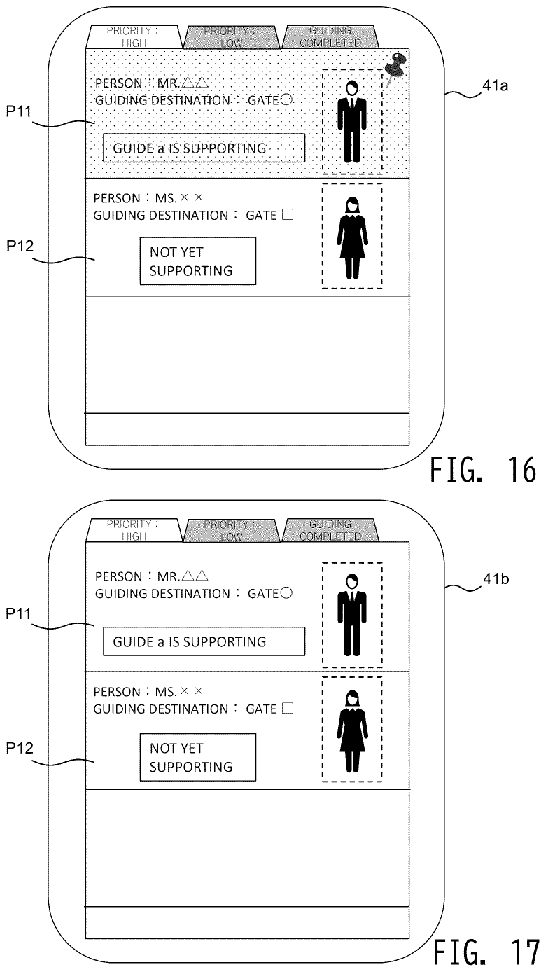

Two staff members may be positioned near the face authentication gate apparatus 23 (e.g., near the staff member A1 in FIG. 4). In this case, each of the two staff members may carry terminal apparatuses 41a and 41b. In this case, the same information (i.e., the notification information) may be transmitted to the terminal apparatuses 41a and 41b from the information processing apparatus 3. Therefore, the information displayed on the terminal apparatuses 41a and 41b may be identical. For example, as illustrated in FIG. 16 and FIG. 17, information about passengers P11 and P12 are displayed on the terminal apparatuses 41a and 41b.

In this case, there is a possibility that the staff member carrying the terminal apparatus 41a and the staff member carrying the terminal apparatus 41b support the same passenger. Therefore, when the staff member carrying the terminal apparatus 41a supports the passenger P11, the information about the passenger P11 may be pinned, as illustrated in FIG. 16. In FIG. 16, a “guide a” indicates the staff member carrying the terminal apparatus 41a.

When the staff member carrying the terminal apparatus 41a performs a predetermined operation and the information about the passenger P11 is thus pinned, the terminal apparatus 41a may determine that the staff member is about to support or is supporting the passenger P11. In this case, the terminal apparatus 41a may change a situation (e.g., status) relating to the passenger P11, from “not yet supporting” to “supporting”. The terminal apparatus 41a may further transmit the status information indicating the situation/status relating to the passenger P11, to the information processing apparatus 3. The status information may include information for identifying the staff member carrying the terminal apparatus 41a, the tracking ID relating to the passenger P11, and the information indicating the status (e.g., supporting) relating to the passenger P11.

The information processing apparatus 3 having received the status information from the terminal apparatus 41a, may transmit information corresponding to the received status information, to the terminal apparatus 41b via the communication apparatus 33. The information corresponding to the status information may include the information for identifying the staff member carrying the terminal apparatus 41a, the tracking ID relating to the passenger P11, and the information indicating the status (e.g., supporting) relating to the passenger P11.

The terminal apparatus 41b may change the situation/status relating to the passenger P11, from “not yet supporting” to the “guide a is supporting”, based on the information received from information processing apparatus 3. As a result, the staff member carrying the terminal apparatus 41b may be notified that the staff member carrying the terminal apparatus 41a is supporting the passenger P11. In this configuration, the staff member carrying the terminal apparatus 41b can support the passenger P12 who is not yet supported. That is, it is possible to prevent/control the staff member carrying the terminal apparatus 41a and the staff member carrying the terminal apparatus 41b from supporting the same passenger.

The terminal apparatus 41a may fix a display position of the information about the passenger P11 pinned. This configuration makes it possible to prevent the display position of the information about the passenger P11 from being changed in a period when the staff member carrying the terminal apparatus 41 a is supporting the passenger.

### (Sixth Modification)

The tracking unit 313 may detect a change in at least one of a face direction and a line of sight of each of the plurality of passengers, based on the first image (i.e., the first image generated by the camera CAM). Existing techniques/technologies may be applied to a method of detecting the face direction and the line of sight. Furthermore, existing techniques/technologies are also applicable to a method of detecting the change in at least one of the face direction and the line of sight, based on at least one of the face direction and the line of sight detected. Therefore, a detailed description of these methods will be omitted. Since the tracking unit 313 may detect the change in at least one of the face direction and the line of sight, it may be referred to as a detection unit.

In addition to the position of the passenger and the position of the terminal apparatus (e.g., at least one of the terminal apparatuses 41 and 42), the determination unit 315 may determine the priority degree, based on the detected change in at least one of the face direction and the line of sight. In this case, the determination unit 315 may increase the priority degree, as the detected change is higher in at least one of the face direction and line of sight.

### (Seventh Modification)

The determination unit 315 may not determine the priority degree. In this case, the determination unit 315 may determine the determination result to be transmitted to the terminal apparatuses 41 and 42 (in other words, the determination result of which at least one of the staff members A1 and A2 is notified), based on the position of the passenger and the positions of the terminal apparatuses 41 and 42. In addition to the terminal apparatuses 41 and 42, there may be another terminal apparatus. In other words, there may be three or more terminal apparatuses.

For example, in a case where a distance between one passenger and the terminal apparatus 41 is shorter than a distance between another passenger and the terminal apparatus 41, the determination unit 315 may transmit the determination result relating to the one passenger to the terminal apparatus 41, in preference to the determination result relating to the other passenger. The one passenger and the other passenger may be the second type of passenger (i.e., the passenger for whom it is determined that there is an applicable person, but who is determined to be not permitted to pass through the face authentication gate apparatus 23), the third type of passenger (i.e., the passenger for whom it is determined that there is no applicable person), or the fourth type of passenger (i.e., the passenger who is determined to be unauthenticated).

The image acquisition unit 311 may acquire a second image including at least one of the staff members A1 and A2. The second image may be generated by the camera CAM imaging at least one of the staff members A1 and A2, or by a camera differing from the camera CAM imaging at least one of the staff members A1 and A2.

The tracking unit 313 may detect the face direction of at least one of the staff members A1 and A2, based on the second image. Since existing techniques/technologies are applicable to a method of detecting the face direction, a detailed description of the method will be omitted. The detection of the face direction of at least one of the staff members A1 and A2 may be performed by a functional block differing from the tracking unit 313. In this case, the arithmetic apparatus 31 may have a functional block for detecting the face direction of at least one of the staff members A1 and A2. Since the tracking unit 313 may detect the face direction, it may be referred to as a face direction detection unit.

The determination unit 315 may determine the determination result to be transmitted to the terminal apparatuses 41 and 42 (in other words, the determination result of which at least one of the staff members A1 and A2 is notified), based on the face direction of at least one of the staff members A1 and A2, in addition to the position of the passenger and the positions of the terminal apparatuses 41 and 42.

The determination unit 315 may determine the determination result to be transmitted to the terminal apparatus 41, based on the position of the passenger and the position of the terminal apparatus 41 (e.g., based on the distance between the passenger and the terminal apparatus 41), from the determination results relating to one or more passengers located in a direction in which a face of the staff member A1 is turned, based on the face direction of the staff member A1. The determination unit 315 may determine not to transmit, to the terminal apparatus 41, the determination results relating to one or more passengers located in a direction in which the face of the staff member A1 is not turned, based on the face direction of the staff member A1.

The determination unit 315 may determine the determination result to be transmitted to the terminal apparatus 42, based on the position of the passenger and the position of the terminal apparatus 42 (e.g., based on the distance between the passenger and the terminal apparatus 42), from the determination results relating to one or more passengers located in a direction in which a face of the staff member A2 is turned, based on the face direction of the staff member A2. The determination unit 315 may determine not to transmit, to the terminal apparatus 42, the determination results relating to one or more passengers located in the direction in which the face of the staff member A2 is not turned, based on the face direction of the staff member A2.

In this case, the tracking unit 313 may estimate the visual recognition range that is a range which can be visual recognized by at least one of the staff members A1 and A2, based on the face direction of at least one of the staff members A1 and A2. The tracking unit 313 may estimate the visual recognition range F1 (see FIG. 4) of the staff member A1, based on the face direction of the staff member A1. The tracking unit 313 may estimate the visual recognition range F2 (see FIG. 4) of the staff member A2, based on the face direction of the staff member A2. Since existing techniques/technologies are applicable to a method of estimating the visual recognition range, a detailed description of the method will be omitted. In a case where the detection of the face direction is performed by a functional block differing from the tracking unit 313, the estimation of the visual recognition range may be performed by the functional block differing from the tracking unit 313.

The determination unit 315 may identify the determination results relating to one or more passengers included in the visual recognition range F1 of the staff member A1, based on the position of the passenger. From the determination results relating to one or more passengers included in the visual recognition range F1 of the staff member A1, the determination unit 315 may determine the determination result to be transmitted to the terminal apparatus 41, based on the position of the passenger and the position of the terminal apparatus 41 (e.g., based on the distance between the passenger and the terminal apparatus 41). The determination unit 315 may determine not to transmit, to the terminal apparatus 41, the determination results relating to one or more passengers excluded in the visual recognition range F1 of the staff member A1.

The determination unit 315 may identify the determination results relating to one or more passengers included in the visual recognition range F2 of the staff member A2, based on the position of the passenger. From the determination results relating to one or more passengers included in the visual recognition range F2 of the staff member A2, the determination unit 315 may determine the determination result to be transmitted to the terminal apparatus 42, based on the position of the passenger and the position of the terminal apparatus 42 (e.g., based on the distance between the passenger and the terminal apparatus 42). The determination unit 315 may determine not to transmit, to the terminal apparatus 42, the determination results relating to one or more passengers excluded in the visual recognition range F2 of the staff member A2.

The determination unit 315 may take into account a moving direction of the passenger, in addition to the visual recognition range (e.g., at least one of the visual recognition ranges F1 and F2) of the staff member (e.g., at least one of the staff members A1 and A2). For example, the tracking unit 313 may estimate the moving direction of each of the plurality of passengers, based on the plurality of first images (i.e., the plurality of first images generated by the camera CAM). Since existing techniques/technologies are applicable to a method of estimating the moving direction from the plurality of images, a detailed description of the method will be omitted.

The determination unit 315 may identify the determination results relating to one or more passengers included in the visual recognition range F1 of the staff member A1, based on the position of the passenger. The determination unit 315 may determine the determination result to be transmitted to the terminal apparatus 41, based on the position of the terminal apparatus 41 and the moving direction of the passenger, from the determination results relating to one or more passengers included in the visual recognition range F1 of the staff member A1. In this case, the determination unit 315 may determine to transmit, to the terminal apparatus 41, the determination result relating to a passenger in a moving direction of approaching the terminal apparatus 41. On the other hand, the determination unit 315 may determine not to transmit, to the terminal apparatus 41, the determination result relating to a passenger in a moving direction of leaving/going away from the terminal apparatus 41.

The determination unit 315 may identify the determination results relating to one or more passengers included in the visual recognition range F2 of the staff member A2, based on the position of the passenger. From the determination results relating to one or more passengers included in the visual recognition range F2 of the staff member A2, the determination unit 315 may determine the determination result to be transmitted to the terminal apparatus 42, based on the position of the terminal apparatus 42 and the moving direction of the passenger. In this case, the determination unit 315 may determine to transmit, to the terminal apparatus 42, the determination result relating to a passenger in a moving direction of approaching the terminal apparatus 42. On the other hand, the determination unit 315 may determine not to transmit, to the terminal apparatus 42, the determination result relating to a passenger in a moving direction of leaving/going away from the terminal apparatus 42.

Alternatively, the determination unit 315 may determine the determination result to be transmitted to the terminal apparatus, based on the position of the terminal apparatus (e.g., at least one of the terminal apparatuses 41 and 42) and the moving direction of the passenger (in this case, the determination unit 315 may not take into account the visual recognition range of the staff member).

The determination unit 315 may determine the determination result to be transmitted to the terminal apparatus 41, based on the position of the terminal apparatus 41 and the moving direction of the passenger, from the determination results relating to the plurality of passengers. In this case, the determination unit 315 may determine to transmit, to the terminal apparatus 41, the determination result relating to the passenger in the moving direction of approaching the terminal apparatus 41. On the other hand, the determination unit 315 may determine not to transmit, to the terminal apparatus 41, the determination result relating to the passenger in the moving direction of leaving/going away from the terminal apparatus 41.

The determination unit 315 may determine the determination result to be transmitted to the terminal apparatus 42, based on the position of the terminal apparatus 42 and the moving direction of the passenger, from the determination results relating to the plurality of passengers. In this case, the determination unit 315 may determine to transmit, to the terminal apparatus 42, the determination result relating to the passenger in the moving direction of approaching the terminal apparatus 42. On the other hand, the determination unit 315 may determine not to transmit, to the terminal apparatus 42, the determination result relating to the passenger in the moving direction of leaving/going away from the terminal apparatus 42.

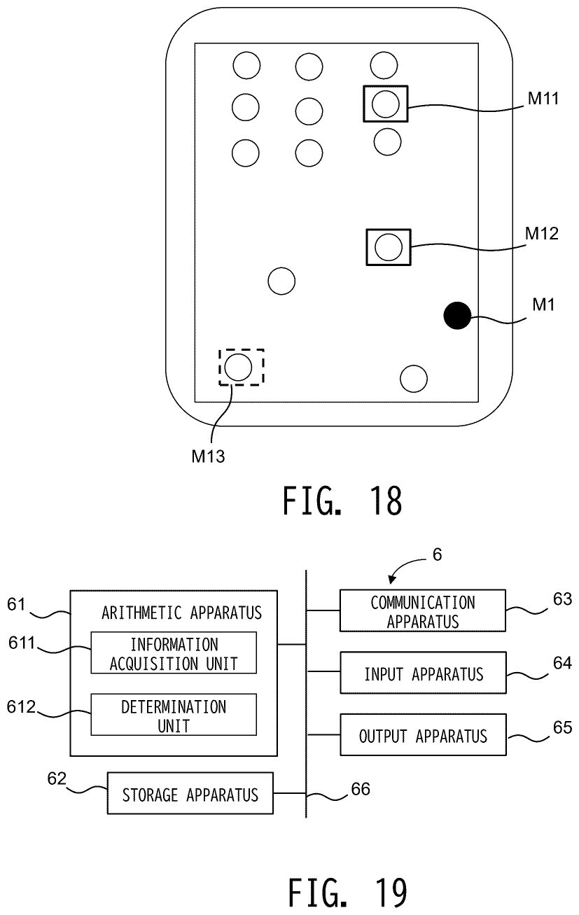

In this case, an image planarly illustrating the position of the terminal apparatus 41 and at least a part of the positions of the plurality of passengers, as illustrated in FIG. 18, may be displayed on the terminal apparatus 41. The position of the terminal apparatus 41 and at least a part of the positions of the plurality of passengers may be superimposed on an airport floor map. The airport floor map may include facility information. The facility information may include store information and equipment information (e.g., at least one of a toilet, a staircase, an escalator, and an elevator hall).

In FIG. 18, a black circle M1 indicates the position of the terminal apparatus 41. A plurality of white circles indicate the positions of the passengers. Solid rectangles M11 and M12 surrounding the white circles indicate that the type of the passenger is the third type (i.e., the passenger for whom it is determined that there is no applicable person) or the fourth type (i.e., the passenger who is determined to be unauthenticated). A dashed rectangle M13 surrounding the white circle indicates that the type of the passenger is the second type (i.e., the passenger for whom it is determined that there is an applicable person, but who is determined to be not permitted to pass through the face authentication gate unit 23). In addition to the position of the terminal apparatus 41 (the black circle M1 in FIG. 18), the position of another terminal apparatus (e.g., the terminal apparatus 42) may be displayed on the terminal apparatus 41.

When the staff member A1 carrying the terminal apparatus 41 taps any one of the rectangles M11, M12 and M13, information about the passenger corresponding to the tapped (in other words, selected) rectangle may be displayed on the terminal apparatus 41. That is, the screen of the terminal apparatus 41 may be transitioned to the screen illustrated in FIG. 15, for example.

Specifically, the terminal apparatus 41 may detect that the staff member A1 taps the screen of the terminal apparatus 41. When the tapping is detected, the terminal apparatus 41 may identify the passenger tapped by the staff member A1 (e.g., the passenger corresponding to one of the rectangles M11, M12, and M13), based on the position of the screen tapped. The terminal apparatus 41 may transition the display from the screen illustrated in FIG. 18 to a screen including information about the identified passenger (e.g., the screen illustrated in FIG. 15).

Furthermore, for example, when the screen illustrated in FIG. 15 is displayed, the terminal apparatus 41 may detect that the staff member A1 taps the screen of the terminal apparatus 41. When the tapping is detected, the terminal apparatus 41 may identify the passenger tapped by the staff member A1, based on the position of the screen tapped. The terminal apparatus 41 may transition the display from the screen illustrated in FIG. 15 to a screen indicating the position of the identified passenger (e.g., the screen illustrated in FIG. 18).

At least one of the terminal apparatuses 41 and 42 may acquire one or more determination results from the information processing apparatus 3. When one of the terminal apparatuses 41 and 42 acquires a plurality of determination results from the information processing apparatus 3, the other terminal apparatus may change the display order of the plurality of determination results, based on the position of each of the plurality of passengers respectively corresponding to the plurality of determination results and based on the position of the other terminal apparatus. In this case, the one terminal apparatus may show the position of the one terminal apparatus and at least a part of the positions of the plurality of passengers (see, e.g., FIG. 18).

### (Eighth Modification)

In place of determining the priority degree based on the type of passenger and the position of the terminal apparatus (e.g., at least one of the terminal apparatuses 41 and 42), the determination unit 315 may determine the priority degree based on the position of the passenger and the position of the terminal apparatus.

For example, the determination unit 315 may determine the priority degree such that the plurality of authentication results are displayed on the terminal apparatus in order of the authentication result of the passenger closer in distance to the terminal apparatus (e.g., at least one of the terminal apparatuses 41 and 42). For example, in a case where the distance between one passenger and terminal apparatus 41 is shorter than the distance between another passenger and terminal apparatus 41, the determination unit 315 may set the priority degree of the authentication result relating to the one passenger, to be higher than the priority degree of the authentication result relating to the other passenger. Based on the priority degree, the determination unit 315 may transmit at least a part of the plurality of authentication results and the position of the passenger corresponding to the at least a part of the authentication results, to the terminal apparatus via the communication apparatus 33. In this case, the determination unit 315 may transmit the authentication results to the terminal apparatus in descending order of the priority degree.

The one passenger and the other passenger may be the second type of passenger (i.e., the passenger for whom it is determined that there is an applicable person, but who is determined to be not permitted to pass through the face authentication gate apparatus 23), the third type of passenger (i.e., the passenger for whom it is determined that there is no applicable person), or the fourth type of passenger (i.e., the passenger who is determined to be unauthenticated). That is, the determination unit 315 may determine the priority degree, based on the position of the passenger and the position of the terminal apparatus, only for the determination results of the second, third, and fourth types of passengers (in other words, the passengers who are determined to not permitted to pass through the face authentication gate apparatus 23).

The image acquisition unit 311 may acquire the second image including at least one of the staff members A1 and A2. The second image may be generated by the camera CAM imaging at least one of the staff members A1 and A2, or by a camera differing from the camera CAM imaging at least one of the staff members A1 and A2.

The tracking unit 313 may detect the face direction of at least one of the staff members A1 and A2, based on the second image. Since existing techniques/technologies are applicable to a method of detecting the face direction, a detailed description of the method will be omitted. The detection of the face direction of at least one of the staff members A1 and A2 may be performed by a functional block differing from the tracking unit 313. In this case, the arithmetic apparatus 31 may have a functional block for detecting the face direction of at least one of the staff members A1 and A2. Since the tracking unit 313 may detect the face direction, it may be referred to as a face direction detection unit.

The determination unit 315 may determine the priority degree of the determination result, based on the face direction of at least one of the staff members A1 and A2, in addition to the position of the passenger and the positions of the terminal apparatuses 41 and 42. The determination unit 315 may set the priority degree of the determination result relating to the passenger located in the direction in which the face of the staff member A1 is not turned, to be lower than the priority degree of the determination result relating to the passenger located in the direction in which the face of the staff member A1 is turned. In a case where there are a plurality of passengers in the direction in which the face of the staff member A1 is turned, the determination unit 315 may determine the priority degree of the determination result of each of the plurality of passengers, based on the position of each of the plurality of passengers and the position of the terminal apparatus 41 (e.g., based on the distance between each of the plurality of passengers and the terminal apparatus 41). In this case, the determination unit 315 may set the priority degree of the determination result in a case of a shorter distance between the passenger and the terminal apparatus 41, to be higher than the priority degree of the determination result in a case of a longer distance between the passenger and the terminal apparatus 41.

The determination unit 315 may set the priority degree of the determination result relating to the passenger located in the direction in which the face of the staff member A2 is not turned, to be lower than the priority degree of the determination result relating to the passenger located in the direction in which the face of the staff member A2 is turned. In a case where there are a plurality of passengers in the direction in which the face of staff member A2 is turned, the determination unit 315 may determine the priority degree of the determination result of each of the plurality of passengers, based on the position of each of the plurality of passengers and the position of the terminal apparatus 42 (e.g., based on the distance between each of the plurality of passengers and the terminal apparatus 42). In this case, the determination unit 315 may set the priority degree of the determination result in a case of a shorter distance between the passenger and the terminal apparatus 42, to be higher than the priority degree of the determination result in a case of a longer distance between the passenger and the terminal apparatus 42.

In this case, the tracking unit 313 may estimate a visual recognition range that is a range which can be visual recognized by at least one of the staff members A1 and A2, based on the face direction of at least one of the staff members A1 and A2. The tracking unit 313 may estimate a visual recognition range F1 (see FIG. 4) of the staff member A1, based on the face direction of the staff member A1. The tracking unit 313 may estimate a visual recognition range F2 (see FIG. 4) of the staff member A2, based on the face direction of the staff member A2. Since existing techniques/technologies are applicable to a method of estimating the visual recognition range, a detailed description of the method will be omitted. In a case where the detection of the face direction is performed by a functional block differing from the tracking unit 313, the estimation of the visual recognition range may be performed by the functional block differing from the tracking unit 313.

The determination unit 315 may identify the determination results relating to one or more passengers included in the visual recognition range F1 of the staff member A1, based on the position of the passenger. The determination unit 315 may set the priority degrees of the determination results relating to the passengers included in the visual recognition range F1 of the staff member A1, to be higher than the priority degrees of the determination results relating to the passengers excluded in the visual recognition range F1. The determination unit 315 may determine the priority degree, based on the position of the passenger and the position of the terminal apparatus 41 (e.g., based on the distance between the passenger and the terminal apparatus 41), for the plurality of determination results relating to the plurality of passengers included in the visual recognition range F1 of the staff member A1. In this case, the determination unit 315 may set the priority degree of the determination result in case of a shorter distance between the passenger and the terminal apparatus 41, to be higher than the priority degree of the determination result in case of a longer distance between the passenger and the terminal apparatus 41.

The determination unit 315 may identify the determination results relating to one or more passengers included in the visual recognition range F2 of the staff member A2, based on the position of the passenger. The determination unit 315 may set the priority degrees of the determination results relating to the passengers included in the visual recognition range F2 of the staff member A2, to be higher than the priority degrees of the determination results relating to the passengers excluded in the visual recognition range F2. The determination unit 315 may determine the priority degree, based on the position of the passenger and the position of the terminal apparatus 42 (e.g., based on the distance between the passenger and the terminal apparatus 42), for the plurality of determination results relating to the plurality of passengers included in the visual recognition range F2 of the staff member A2. In this case, the determination unit 315 may set the priority degree of the determination result in case of a shorter distance between the passenger and the terminal apparatus 42, to be higher than the priority degree of the determination result in case of a longer distance between the passenger and the terminal apparatus 42.

The determination unit 315 may take into account the moving direction of the passenger, in addition to the visual recognition range (e.g., at least one of the visual recognition ranges F1 and F2) of the staff member (e.g., at least one of the staff members A1 and A2). For example, the tracking unit 313 may estimate the moving direction of each of the plurality of passengers, based on the plurality of first images (i.e., the plurality of first images generated by the camera CAM). Since various existing aspects are applicable to a method of estimating the moving direction from the plurality of images, a detailed description of the method will be omitted.

The determination unit 315 may identify the determination results relating to one or more passengers included in the visual recognition range F1 of the staff member A1, based on the position of the passenger. The determination unit 315 may determine the priority degrees of the determination results relating to one or more passengers included in the visual recognition range F1 of the staff member A1, based on the position of the terminal apparatus 41 and the moving direction of the passenger. In this case, the determination unit 315 may set the priority degree of the determination result relating to the passenger in the moving direction of approaching the terminal apparatus 41, to be higher than the priority degree of the determination result relating to the passenger in the moving direction of leaving/going away from the terminal apparatus 41.

The determination unit 315 may identify the determination results relating to one or more passengers included in the visual recognition range F2 of the staff member A2, based on the position of the passenger. The determination unit 315 may determine the priority degrees of the determination results relating to one or more passengers included in the visual recognition range F2 of the staff member A2, based on the position of the terminal apparatus 42 and the moving direction of the passenger. In this case, the determination unit 315 may set the priority degree of the determination result relating to the passenger in the moving direction of approaching the terminal apparatus 42, to be higher than the priority degree of the determination result relating to the passenger in the moving direction of leaving/going away from the terminal apparatus 42.

Alternatively, the determination unit 315 may determine the priority degree of the determination result, based on the position of the terminal apparatus (e.g., at least one of the terminal apparatuses 41 and 42) and the moving direction of the passenger (in this case, the determination unit 315 may not take into account the visual recognition range of the staff member).

The determination unit 315 may determine the priority degree of the determination result, based on the position of the terminal apparatus 41 and the moving direction of the passenger. In this case, the determination unit 315 may set the priority degree of the determination result relating to the passenger in the moving direction of approaching the terminal apparatus 41, to be higher than the priority degree of the determination result relating to the passenger in the moving direction of leaving/going away from the terminal apparatus 41.

The determination unit 315 may determine the priority degree of the determination result, based on the position of the terminal apparatus 42 and the moving direction of the passenger. In this case, the determination unit 315 may set the priority degree of the determination result relating to the passenger in the moving direction of approaching the terminal apparatus 42, to be higher than the priority degree of the determination result relating to the passenger in the moving direction of leaving/going away from the terminal apparatus 42.

In this case, an image planarly illustrating the position of the terminal apparatus 41 and at least a part of the positions of the plurality of passengers, as illustrated in FIG. 18, may be displayed on the terminal apparatus 41. The position of the terminal apparatus 41 and at least a part of the positions of the plurality of passengers may be superimposed on an airport floor map. The airport floor map may include facility information. The facility information may include store information and equipment information (e.g., at least one of a toilet, a staircase, an escalator, and an elevator hall).

In FIG. 18, the black circle M1 indicates the position of the terminal apparatus 41. The plurality of white circles indicate the positions of the passengers. The solid rectangles M11 and M12 surrounding the white circles indicate that the type of the passenger is the third type (i.e., the passenger for whom it is determined that there is no applicable person) or the fourth type (i.e., the passenger who is determined to be unauthenticated). The dashed rectangle M13 surrounding the white circle indicates that the type of the passenger is the second type (i.e., the passenger for whom it is determined that there is an applicable person, but who is determined to be not permitted to pass through the face authentication gate unit 23). In addition to the position of the terminal apparatus 41 (the black circle M1 in FIG. 18), the position of another terminal apparatus (e.g., the terminal apparatus 42) may be displayed on the terminal apparatus 41.

When the staff member A1 carrying the terminal apparatus 41 taps any one of the rectangles M11, M12 and M13, information about the passenger corresponding to the tapped (in other words, selected) rectangle may be displayed on the terminal apparatus 41. That is, the screen of the terminal apparatus 41 may be transitioned to the screen illustrated in FIG. 15, for example.

Specifically, the terminal apparatus 41 may detect that the staff member A1 taps the screen of the terminal apparatus 41. When the tapping is detected, the terminal apparatus 41 may identify the passenger tapped by the staff member A1 (e.g., the passenger corresponding to one of the rectangles M11, M12, and M13), based on the position of the screen tapped. The terminal apparatus 41 may transition the display from the screen illustrated in FIG. 18 to the screen including the information about the identified passenger (e.g., the screen illustrated in FIG. 15).

Furthermore, for example, when the screen illustrated in FIG. 15 is displayed, the terminal apparatus 41 may detect that the staff member A1 taps the screen of the terminal apparatus 41. When the tapping is detected, the terminal apparatus 41 may identify the passenger tapped by the staff member A1, based on the position of the screen tapped. The terminal apparatus 41 may transition the display from the screen illustrated in FIG. 15 to the screen indicating the position of the identified passenger (e.g., the screen illustrated in FIG. 18).

The information processing apparatus 3 may not include the face authentication unit 314. In this case, as in the first modification described above, the face authentication processing may be performed by the authentication apparatus 5 differing from the information processing apparatus 3. In this case, the information processing apparatus 3 and the authentication apparatus 5 may constitute one information processing system. It can be said that the information processing system includes: the image acquisition unit 311 that acquires the first image including the predetermined area RA through which a plurality of passengers pass; the face authentication unit 51 that performs the face authentication by using the first image; the information acquisition unit 312 that acquires the position of the terminal apparatus (e.g., at least one of the terminal apparatuses 41 and 42) carried by the staff member (e.g., at least one of the staff members A1 and A2); and the determination unit 315 that determines the priority degree for notification of the plurality of authentication results of the face authentication, on the basis of the position of the terminal apparatus and the positions of the plurality of passengers detected based on the first image.

### Third Example Embodiment

An information processing apparatus according to a third example embodiment will be described. The following describes the information processing apparatus, an information processing method, and a recording medium according to the third example embodiment, by using the information processing apparatus 3 and a terminal apparatus 6. The third example embodiment partially differs from the second example embodiment, in the operation of the determination unit 315. The third example embodiment may be the same as the second example embodiment in the other points. The terminal apparatus 6 is a terminal apparatus corresponding to at least one of the terminal apparatuses 41 and 42 in the second example embodiment described above.

In FIG. 19, the terminal apparatus 6 includes an arithmetic apparatus 61, a storage apparatus 62, a communication apparatus 63, an input apparatus 64, and an output apparatus 65. The arithmetic apparatus 61, the storage apparatus 62, the communication apparatus 63, the input apparatus 64, and the output apparatus 65 may be connected via a data bus 66. The arithmetic apparatus 61 includes an information acquisition unit 611 and a determination unit 612, as logically realized functional blocks or as physically realized processing circuits. The terminal apparatus 6 may be connected to the information processing apparatus 3 via the network NW.

The information acquisition unit 611 of the arithmetic apparatus 61 may acquire the ID correspondence table 321 from the information processing apparatus 3. The information acquisition unit 611 may store the ID correspondence table 321 in the storage apparatus 62.

The determination unit 612 of the arithmetic apparatus 61 may output the determination result for each of the plurality of passengers, based on the ID correspondence table 321. The determination unit 612 may output, as the determination result for each of the passengers, any one of (i) a first determination result indicating that there is an applicable person and the passenger is permitted to pass through the face authentication gate unit 23, (ii) a second determination result indicating that there is an applicable person, but the passenger is not permitted to pass through the face authentication gate unit 23, (iii) a third determination result indicating that there is no applicable person, and (iv) a fourth determination result indicating that the passenger is unauthenticated. That is, the determination unit 612 may classify the plurality of passengers into any one of a first type corresponding to the first determination result, a second type corresponding to the second determination result, a third type corresponding to the third determination result, and a fourth type corresponding to the fourth determination result.

The determination unit 612 may determine the priority degree of the determination result relating to the passenger, on the basis of: the type relating to the passenger based on the determination result; and a position of the terminal apparatus 6 (i.e., its own position). The determination unit 612 may determine whether or not to display the determination result relating to the passenger, based on the determined priority degree. That is, the determination unit 612 may change display content, based on the priority degree. Since the display content is changed based on the priority degree, the priority degree may be referred to as a “priority degree of display”.

In this example embodiment, the information processing apparatus 3 may not include the determination unit 315. Alternatively, the determination unit 315 may output the determination result for each of the plurality of passengers, based on the ID correspondence table 321. The determination unit 315 may transmit the determination result relating to each of the plurality of passengers, to the terminal apparatus 6 via the communication apparatus 33. The determination unit 612 may determine the priority degree of the determination result relating to one passenger, on the basis of the position of the terminal apparatus 6 and the type relating to the one passenger based on the determination result for each of the plurality of passengers transmitted from the determination unit 315. The priority degree may be determined by the determination unit 315 of the information processing apparatus 3. In this case, the determination unit 612 may determine whether or not to display the determination result, based on the priority degree determined by the determination unit 315.

The operation of the terminal apparatus 6 described above may be realized by the terminal apparatus 6 reading a computer program recorded on a recording medium. In this case, it can be said that a computer program that allows the terminal apparatus 6 to perform the above-described operation is recorded on the recording medium.

### (Technical Effect)

According to the information processing apparatus 3, it is possible to prevent/control the person not being permitted to pass through the face authentication gate apparatus 23 from entering the face authentication gate apparatus 23. Therefore, according to the information processing apparatus 3, it is possible to prevent/control the reduction in the throughput of the face authentication gate apparatus.

### (Modification)

As in the eighth modification of the second example embodiment described above, the determination unit 612 may determine the priority degree, based on the position of the passenger and the position of the terminal apparatus. The determination unit 612 may change the display content, based on the determined priority degree.

### <Supplementary Notes>

With respect to the example embodiment described above, the following Supplementary Notes are further disclosed.

### (Supplementary Note 1)

An information processing apparatus including:
an image acquisition unit that acquires a first image including a predetermined area through which a plurality of authentication subjects pass;
an information acquisition unit that acquires a position of a terminal apparatus carried by a user; and
a determination unit that determines a priority degree of notification of a plurality of authentication results of face authentication performed by using the first image, based on the position of the terminal apparatus, and positions of the plurality of authentication subjects detected based on the first image.

### (Supplementary Note 2)

The information processing apparatus according to Supplementary Note 1, wherein the determination unit determines the priority degree such that notification of the plurality of authentication results is given in order of an authentication result of an authentication subject closer in distance to the terminal apparatus.

### (Supplementary Note 3)

The information processing apparatus according to Supplementary Note 2, wherein
the plurality of authentication subjects include a first authentication subject and a second authentication subject,
the positions of the plurality of authentication subjects include a position of the first authentication subject and a position of the second authentication subject,
the plurality of authentication results include a first authentication result that is a result of the face authentication performed on the first authentication subject, and a second authentication result that is a result of the face authentication performed on the second authentication subject, and
the determination unit sets a priority degree of the first authentication result to be higher than a priority degree of the second authentication result, in response to the first authentication subject being closer to the terminal apparatus than the second authentication subject, based on the position of the terminal apparatus, the position of the first authentication subject, and the position of the second authentication subject.

### (Supplementary Note 4)

The information processing apparatus according to any one of Supplementary Notes 1 to 3, wherein the determination unit transmits, to the terminal apparatus, at least a part of the plurality of authentication results and a position of an authentication subject corresponding to the at least a part of the authentication results, based on the priority degree.

### (Supplementary Note 5)

The information processing apparatus according to any one of Supplementary Notes 1 to 4, wherein
the image acquisition unit acquires a second image including the user,
the information processing apparatus includes a face direction detection unit that detects a face direction of the user, based on the second image, and
the determination unit determines the priority degree, based on the position of the terminal apparatus, the detected face direction, and the positions of the plurality of authentication subjects.

### (Supplementary Note 6)

The information processing apparatus according to Supplementary Note 5, wherein
the face direction detection unit estimates a visual recognition range that is a range which can be visual recognized by the user from the detected face direction, and
the determination unit determines the priority degree, based on the position of the terminal apparatus, the estimated visual recognition range, and the positions of the plurality of authentication subjects.

### (Supplementary Note 7)

The information processing apparatus according to Supplementary Note 6, wherein
the determination unit estimates a moving direction of each of the plurality of authentication subjects, based on a plurality of first images, and
the determination unit determines the priority degree, based on the position of the terminal apparatus, the estimated visual recognition range, and the moving direction of each of the plurality of authentication subjects.

### (Supplementary Note 8)

The information processing apparatus according to any one of Supplementary Notes 1 to 4, wherein
the determination unit estimates a moving direction of each of the plurality of authentication subjects, based on a plurality of first images, and
the determination unit determines the priority degree, based on the position of the terminal apparatus and the moving direction of each of the plurality of authentication subjects.

### (Supplementary Note 9)

The information processing apparatus according to any one of Supplementary Notes 1 to 8, wherein
the predetermined area is an area through which a person passes toward the face authentication gate device,
the authentication result includes first type information indicating that an authentication subject is permitted to pass through the face authentication gate apparatus, or second type information indicating that an authentication subject is not permitted to pass through the face authentication gate apparatus, and
the determination unit determines the priority degree, based on the position of the terminal apparatus and the positions of the plurality of authentication subjects, for an authentication result including the second type information among the plurality of authentication results.

### (Supplementary Note 10)

The information processing apparatus according to any one of Supplementary Notes 1 to 9, wherein the information processing apparatus includes an authentication unit that performs face authentication by using the first image.

### (Supplementary Note 11)

An information processing method including:
acquiring a first image including a predetermined area through which a plurality of authentication subjects pass;
acquiring a position of a terminal apparatus carried by a user; and
determining a priority degree of notification of a plurality of authentication results of face authentication performed by using the first image, based on the position of the terminal apparatus, and positions of the plurality of authentication subjects detected based on the first image.

### (Supplementary Note 12)

A recording medium on which a computer program that allows a computer to execute an information processing method is recorded, the information processing method including:
acquiring a first image including a predetermined area through which a plurality of authentication subjects pass;
acquiring a position of a terminal apparatus carried by a user; and
determining a priority degree of notification of a plurality of authentication results of face authentication performed by using the first image, based on the position of the terminal apparatus, and positions of the plurality of authentication subjects detected based on the first image.

### (Supplementary Note 13)

An information processing system including:
an image acquisition unit that acquires a first image including a predetermined area through which a plurality of authentication subjects pass;
an authentication unit that performs face authentication by using the first image;
an information acquisition unit that acquires a position of a terminal apparatus carried by a user; and
a determination unit that determines a priority degree of notification of a plurality of authentication results of the face authentication, based on: the position of the terminal apparatus and positions of the plurality of authentication subjects detected based on the first image.

### (Supplementary Note 14)

A display method including:
acquiring at least a part of a plurality of authentication results of face authentication performed by using a first image including a predetermined area through which a plurality of authentication subjects pass; and
changing a display order of the at least a part of the authentication results, based on a position of a terminal apparatus carried by a user, and positions of the plurality of authentication subjects detected based on the first image.

### (Supplementary Note 15)

The display method according to claim 14, including:
illustrating the position of the terminal apparatus, and at least a part of the plurality of authentication subjects.

### (Supplementary Note 16)

A Terminal Apparatus Carried by a User, Including:
an acquisition unit that acquires at least a part of a plurality of authentication results of face authentication performed by using a first image including a predetermined area through which a plurality of authentication subjects pass; and
a display unit that changes display content, based on a priority degree of display, wherein
the display content includes the at least a part of the plurality of authentication results, and
the priority degree is determined, based on a position of the terminal apparatus, and positions of the plurality of authentication subjects detected based on the first image.

### (Supplementary Note 17)

The terminal apparatus according to Supplementary Note 16, wherein the terminal apparatus includes a determination unit that determines the priority degree, based on the position of the terminal apparatus, and the positions of the plurality of authentication subjects detected based on the first image.

This disclosure is not limited to the example embodiments described above, but is allowed to be changed, if desired, without departing from the essence or spirit of this disclosure which can be read from the claims and the entire specification. An information processing apparatus, an information processing method, and a recording medium with such changes are also intended to be within the technical scope of the present disclosure.

### DESCRIPTION OF REFERENCE CODES

1, 3 Information processing apparatus
2 Airport System
5 Authentication apparatus
6, 41, 42 Terminal apparatus
11, 311 Image acquisition unit
12, 312 Information acquisition unit
13, 315 Determination unit
21 Management Server
22 Check-in terminal
23 Face authentication gate apparatus
24 Normal gate apparatus
31 Arithmetic unit
32 Storage apparatus
33 Communication apparatus
34 Input apparatus
35 Output apparatus
36, 52, 211, 232 Face database
51, 314 Face authentication unit
313 Tracking unit

What is claimed is:

1. An information processing apparatus comprising:
at least one memory that is configured to store instructions; and
at least one processor that is configured to execute the instructions to:
acquire a first image including a predetermined area through which a plurality of authentication subjects pass;
acquire a position of a terminal apparatus carried by a user; and
determine a priority degree of notification of a plurality of authentication results of face authentication performed by using the first image, based on the position of the terminal apparatus, and positions of the plurality of authentication subjects detected based on the first image.

2. The information processing apparatus according to claim 1, wherein the at least one processor is configured to execute the instructions to determine the priority degree such that notification of the plurality of authentication results is given in order of an authentication subject closer in distance to the terminal apparatus.

3. The information processing apparatus according to claim 2, wherein
the plurality of authentication subjects include a first authentication subject and a second authentication subject,
the positions of the plurality of authentication subjects include a position of the first authentication subject and a position of the second authentication subject,
the plurality of authentication results include a first authentication result that is a result of the face authentication performed on the first authentication subject, and a second authentication result that is a result of the face authentication performed on the second authentication subject, and
the at least one processor is configured to execute the instructions to set a priority degree of the first authentication result to be higher than a priority degree of the second authentication result, in response to the first authentication subject being closer to the terminal apparatus than the second authentication subject, based on the position of the terminal apparatus, the position of the first authentication subject, and the position of the second authentication subject.

4. The information processing apparatus according to claim 1, wherein the at least one processor is configured to execute the instructions to transmit, to the terminal apparatus, at least a part of the plurality of authentication results and a position of an authentication subject corresponding to the at least a part of the authentication results, based on the priority degree.

5. The information processing apparatus according to claim 1, wherein
the at least one processor is configured to execute the instructions to:
acquire a second image including the user;
detect a face direction of the user, based on the second image; and
determine the priority degree, based on the position of the terminal apparatus, the detected face direction, and the positions of the plurality of authentication subjects.

6. The information processing apparatus according to claim 5, wherein
the at least one processor is configured to execute the instructions to:
estimate a visual recognition range that is a range which can be visual recognized by the user from the detected face direction; and
determine the priority degree, based on the position of the terminal apparatus, the estimated visual recognition range, and the positions of the plurality of authentication subjects.

7. The information processing apparatus according to claim 6, wherein
the at least one processor is configured to execute the instructions to:
estimate a moving direction of each of the plurality of authentication subjects, based on a plurality of first images; and
determine the priority degree, based on the position of the terminal apparatus, the estimated visual recognition range, and the moving direction of each of the plurality of authentication subjects.

8. The information processing apparatus according to claim 1, wherein
the at least one processor is configured to execute the instructions to:
estimate a moving direction of each of the plurality of authentication subjects, based on a plurality of first images; and
determine the priority degree, based on the position of the terminal apparatus and the moving direction of each of the plurality of authentication subjects.

9. The information processing apparatus according to claim 1, wherein
the predetermined area is an area through which a person passes toward the face authentication gate device,
the authentication result includes first type information indicating that an authentication subject is permitted to pass through the face authentication gate apparatus, or second type information indicating that an authentication subject is not permitted to pass through the face authentication gate apparatus, and
the at least one processor is configured to execute the instructions to determine the priority degree, based on the position of the terminal apparatus and the positions of the plurality of authentication subjects, for an authentication result including the second type information among the plurality of authentication results.

10. The information processing apparatus according to claim 1, wherein the at least one processor is configured to execute the instructions to perform face authentication by using the first image.

11. An information processing method comprising:
acquiring a first image including a predetermined area through which a plurality of authentication subjects pass;
acquiring a position of a terminal apparatus carried by a user; and
determining a priority degree of notification of a plurality of authentication results of face authentication performed by using the first image, based on the position of the terminal apparatus, and positions of the plurality of authentication subjects detected based on the first image.

12. A non-transitory recording medium on which a computer program that allows a computer to execute an information processing method is recorded, the information processing method including:
acquiring a first image including a predetermined area through which a plurality of authentication subjects pass;
acquiring a position of a terminal apparatus carried by a user; and
determining a priority degree of notification of a plurality of authentication results of face authentication performed by using the first image, based on the position of the terminal apparatus, and positions of the plurality of authentication subjects detected based on the first image.

13-17. (canceled)
